(19) United States
(12) Patent Application Publication
(10) Pub. No.: US 2025/0259639 A1
(43) Pub. Date: Aug. 14, 2025

(54) AUDIO SOURCE SEPARATION USING MULTI-MODAL AUDIO SOURCE CHANNALIZATION SYSTEM

(71) Applicant: SHURE ACQUISITION HOLDINGS, INC., Niles, IL (US)

(72) Inventors: Bibo GAO, Buffalo Grove, IL (US); Wenshun TIAN, Palatine, IL (US); Michael LESTER, Buena Vista, CO (US); Daniel LAW, Glencoe, IL (US); Yichong YAN, Prosper, TX (US)

(21) Appl. No.: 19/047,204

(22) Filed: Feb. 6, 2025

Related U.S. Application Data
(60) Provisional application No. 63/551,121, filed on Feb. 8, 2024.

(51) Int. Cl. G10L 21/028; G06V 20/40; G06V 40/10; G10L 17/02; G10L 25/57

(52) U.S. Cl. CPC G10L 21/028; G06V 20/46; G06V 40/10; G10L 17/02; G10L 25/57

(57) ABSTRACT

Various embodiments of the present disclosure provide methods, apparatuses, systems, and/or devices that are configured to separate multi-source audio signal samples into discrete source separated channel audio samples using trained multi-modal audio source channelization models. Multi-source audio signal samples are difficult to separate because they can include multiple target audio sources (e.g., individual speakers) that are often inter-mixed and overlaid with other audio sources such as noise, music, reverberations, and other audio artifacts. The multi-modal audio source channelization models discussed herein are trained to generate source separated channel audio samples based on audio signal samples and on video signal samples.

### CROSS-REFERENCE TO RELATED APPLICATIONS

This application claims the benefit of U.S. Provisional Patent Application No. 63/551,121, filed Feb. 8, 2024, the entire contents of which are hereby incorporated by reference in its entirety.

### BACKGROUND

Applicant has identified many deficiencies and problems associated with existing methods, apparatus, and systems related to processing audio signals. Through applied effort, ingenuity, and innovation, many of these identified deficiencies and problems have been solved by developing solutions that are configured in accordance with embodiments of the present disclosure, many examples of which are described in detail herein.

### BRIEF SUMMARY

Various embodiments of the present disclosure are directed to improved apparatuses, systems, methods, and computer readable media for providing an artificial intelligence enabled multi-modal audio source channelization system. These characteristics as well as additional features, functions, and details of various embodiments are described below. Similarly, corresponding and additional embodiments are also described below.

### BRIEF DESCRIPTION OF THE DRAWINGS

Having thus described some embodiments in general terms, references will now be made to the accompanying drawings, which are not necessarily drawn to scale, and wherein:

FIG. 1 illustrates an example audio environment that includes multiple target audio sources, multiple video capture devices, multiple audio capture devices, and a multi-modal audio source channelization system configured in accordance with one or more embodiments disclosed herein;

FIG. 2A illustrates an example schematic flow diagram of example operations performed in real time or near real time by an example multi-modal audio source channelization system in accordance with one or more embodiments disclosed herein;

FIG. 2B illustrates an example schematic flow diagram of example operations performed in real time or near real time by an example multi-modal audio source channelization system deployed in a video bar in accordance with one or more embodiments disclosed herein;

FIG. 3 illustrates an example model architecture for use within an example multi-modal audio source channelization model configured in accordance with one or more embodiments disclosed herein;

FIG. 4 illustrates an example architecture for use within an example multi-modal audio source channelization system configured in accordance with one or more embodiments disclosed herein;

FIG. 5 depicts an example schematic flow diagram of example operations performed by an example multi-modal audio source channelization system configured in accordance with one or more embodiments disclosed herein.

FIG. 6 illustrates a schematic diagram of example operational flows performed by an example multi-modal audio source channelization system in accordance with one or more embodiments disclosed herein;

FIG. 7 illustrates an example video frame of a video signal sample structured in accordance with one or more embodiments disclosed herein;

FIG. 8 illustrates an example model architecture for use within an example speaking indication sub model in accordance with one or more embodiments disclosed herein;

FIG. 9 illustrates an example model architecture for use within an example face identification sub model in accordance with one or more embodiments disclosed herein;

FIG. 10 illustrates an example model architecture for use within an example video feature extraction model in accordance with one or more embodiments disclosed herein;

FIG. 11 illustrates an example model architecture for use within an example audio feature extraction model in accordance with one or more embodiments disclosed herein;

FIG. 12 illustrates an example model architecture for use within an example source spatialization model in accordance with one or more embodiments disclosed herein;

FIG. 13 illustrates a schematic diagram of an example operational flows for training one or more multi-modal audio source channelization systems in accordance with one or more embodiments disclosed herein;

FIG. 14 illustrates an example method for using one or more multi-modal audio source channelization systems in accordance with one or more embodiments disclosed herein; and

FIG. 15 illustrates an example audio signal processing apparatus configured in accordance with one or more embodiments disclosed herein.

### DETAILED DESCRIPTION OF VARIOUS EMBODIMENTS

Various embodiments of the present disclosure are described more fully hereinafter with reference to the accompanying drawings, in which some, but not all embodiments of the disclosure are shown. Indeed, the disclosure may embody many different forms and should not be construed as limited to the embodiments set forth herein. Rather, these embodiments are provided so that this disclosure will satisfy applicable legal requirements.

### Overview

Various embodiments of the present disclosure address technical problems associated with accurately, efficiently, and/or reliably separating target audio sources from a multi-source audio signal sample produced from a dynamic and complex audio environment (e.g., permutation ambiguity problem). Multi-source audio signal samples produced from such environments can include multiple target audio sources (e.g., individual speakers) that are often inter-mixed and overlaid with other audio sources such as noise, music, reverberations, other audio artifacts, and the like. Even speech from the multiple target audio sources may prove difficult to isolate because such speech may be overlaid one atop the next in circumstances where multiple individuals are speaking at once.

Example solutions discussed herein address the above technical challenges by employing a multi-modal audio source channelization system that is configured to generate one or more source separated channel audio samples from a multi-source audio signal sample. The disclosed multi-modal audio source channelization system is configured to generate the one or more source separated channel audio samples by using a trained multi-modal audio source channelization model. Each of the generated one or more source separated channel audio samples includes only audio generated from a single target audio source and excludes or masks audio from other sources (for example, undesirable audio, extraneous audio sources, non-stationary noise, non-localized audio, and the like).

It is notable that the multi-modal audio source channelization model is trained to generate source separated channel audio samples based on audio signal samples and on video signal samples. Such audio signal samples and video signal samples may undergo feature extraction operations prior to application of the multi-modal audio source channelization model as discussed in greater detail below.

Certain undesirable approaches to audio source separation may rely exclusively on manual placement of directional microphones or steering microphone beams toward a desired audio source. While these techniques may be used to enhance operation of example solutions discussed herein, they are not required to obtain desirable audio source separation results. Various solutions discussed herein may also include optional preprocessing and/or post-processing operations (e.g., to perform beamforming, digital signal processing, audio mixing, etc.).

Certain other undesirable approaches to audio source separation may employ trained machine learning models. However, such trained machine learning models are configured to operate on single audio waveforms and do not leverage sensor information from different non-audio sensor modalities (e.g., video capture devices).

To address these and/or other technical deficiencies associated with undesirable audio source separation systems, various example solutions disclosed herein provide a multi-modal audio source channelization system that is configured to provide improved source channelization, source separation, source localization, and to otherwise isolate target audio sources from a multi-source audio signal sample. The multi-modal audio source channelization system disclosed herein is configured to identify and separate multiple targeted audio sources (e.g., multiple simultaneous speakers) based on multi-modal training data from audio and non-audio modalities (e.g., one or more audio capture devices and one or more video capture devices).

The disclosed techniques enable a multi-modal audio source channelization system to train and apply sophisticated machine learning models to both more efficiently and more effectively isolate targeted audio and ignore noise/defects from audio signal samples relative to manually configured techniques such as those involving traditional acoustic audio processing, acoustic beamforming, digital signal processing, or other methods that attempt to filter out or remove defects from the audio signal samples. That is, because techniques herein can completely ignore unwanted components of audio signal samples, techniques disclosed herein can isolate and/or regenerate targeted or desired audio without the need for reducing or suppressing undesired audio. Moreover, the disclosed techniques reduce the need for manual supervision of denoising/defect removal frameworks utilized in some undesirable audio signal processing systems, thus further improving efficiency and utility of the herein disclosed audio signal processing systems.

Example multi-modal audio source channelization systems configured as discussed herein are configured to produce improved audio signals with reduced or eliminated noise (e.g., stationary and/or non-stationary noise) even in view of exacting audio latency requirements. Improved multi-modal audio source channelization system embodiments as discussed herein may employ a fewer number of computing resources when compared to less undesirable audio processing systems that are used for digital signal processing and denoising.

Additionally or alternatively, improved audio processing systems described herein may be configured to deploy a smaller number of memory resources allocated to denoising, echo removal, source separating, source localizing, or beamforming of an audio signal sample. Improved multi-modal audio source channelization systems are configured to improve processing speed of denoising, echo removal, source separating, source localizing, beamforming operations, and/or to reduce the computational resources associated with applying machine learning models to such tasks. These improvements enable deployment of the improved audio processing systems discussed herein in microphones or other hardware/software configurations where processing and memory resources are limited, and/or where processing speed and reduced audio latency is important.

### Example Multi-Modal Audio Source Channelization Systems and Methods

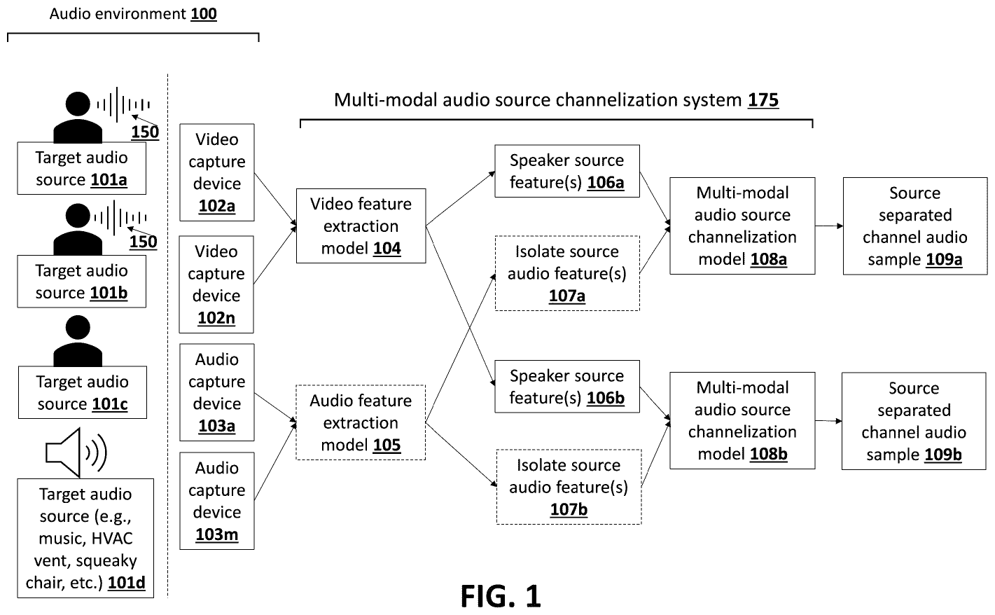

FIG. 1 illustrates an example audio environment 100 that includes multiple target audio sources 101a-101d, multiple video capture devices 102a-102n, multiple audio capture devices 103a-103m, and a multi-modal audio source channelization system 175. The depicted environment may be an indoor environment, an outdoor environment, an entertainment environment, a room, a classroom, a lecture hall, a performance hall, a broadcasting environment, a sports stadium or arena, a virtual environment, an automobile passenger environment, or the like.

The term “target audio source” refers to an audio emitting entity. For example, in an environment with three individuals speaking, each of the individuals speaking may correspond to a respective target audio source such that there are three target audio sources. In some examples, the term target audio source refers to speaking and non-speaking audio sources. For example, in an environment with two individuals speaking, a music player playing music, and a noisy street positioned outside of a window, each of the individuals speaking, the music player, and the noisy street may correspond to a respective target audio source such that there are four target audio sources. Each target audio source may be channelized and isolated from other target audio sources using the disclosed multi-modal audio source channelization system.

The term “audio capture device” refers to an audio capturing device, such as a microphone, configured for capturing or recording audio by converting sound into one or more electrical signals. An audio capture device can be a condenser microphone, a dynamic microphone, a piezoelectric microphone, an array microphone, one or more beamformed lobes of an array microphone, a linear array microphone, a ceiling array microphone, a table array microphone, a virtual microphone, a network microphone, a ribbon microphone, a micro-electro-mechanical systems (MEMS) microphone, an in-ear microphone, or other types of audio capture device that will be apparent to one of ordinary skill in the art in view of this disclosure.

An audio capture device as referenced herein can be associated with a polar pattern such as unidirectional, omnidirectional, bi-directional, cardioid, or another polar pattern. An audio capture device can be configured as a single microphone and/or a single beamformed lobe. An audio capture device can also be configured as multiple microphones and/or multiple beamformed lobes. The disclosed audio capture device can be a wireless or wired microphone.

An audio capture device can be a single microphone, a single microphone array or multiple microphone arrays. An audio capture device can be associated with a conferencing system (e.g., an audio-conferencing system, a video conferencing system, a digital conference system, etc.), an audio performance system (e.g., a theatrical audio system, a cinematic audio system, a radio or television broadcast system, a gaming system, an augmented reality system, a virtual reality system, etc.), and/or an audio recording system (e.g., a recording studio system, a podcast recording system, etc.).

The term “video capture device” refers to a device including one or more sensors configured for capturing video and/or visual imagery by converting light into electrical signals. The video and/or visual imagery captured by a video capture device may be converted into video data. The video data may be a digital video data and/or digital image data or, alternatively, analog video data and/or analogy image data.

Video capture devices include cameras, smartphone cameras, 3D cameras, digital cameras, video cameras, video recorders, and/or any other device that is configured for video capture. A 3D camera may include, but is not limited to: LiDAR, RADAR, inertial measurement units (IMUs), magnetic field sensors, accelerometers, gyroscopes, or another type of sensor capable of capturing video, imagery, and/or position. In some embodiments, video data may be augmented with position and/or orientation data provided by a 3D camera. Such position and/or orientation data may form part of target audio spatial data as discussed in greater detail below.

The four target audio sources 101a-d depicted in FIG. 1 are positioned in an audio environment 100 with two or more audio capture devices 103a-m (e.g., microphones or microphone arrays) and two or more video capture devices 102a-n (e.g., video cameras). To illustrate one of the desirable features of certain embodiments discussed herein, target audio sources 101a-b shown in FIG. 1 embody two individuals that are simultaneously speaking. Such simultaneous speaking is indicated by simultaneous audio indicators 150.

Target audio source 101c represents another individual in the room that is not simultaneously speaking with target audio sources 101a-b. Target audio source 101d represents another ambient sound source positioned in the audio environment such as music playing in the background, a heating, ventilation, and air conditioning (HVAC) vent, a squeaky chair, etc.

The two or more audio capture devices 103a-m and two or more video capture devices 102a-n may be positioned throughout the audio environment in a variety of configurations depending on the use case. For example, if the depicted audio environment were a conference room, the audio capture devices 103a-m may be ceiling installed array microphones positioned above target audio sources 101a-d. The video capture devices 102a-n may be part of a video conferencing system and positioned on one or more walls of the conference room.

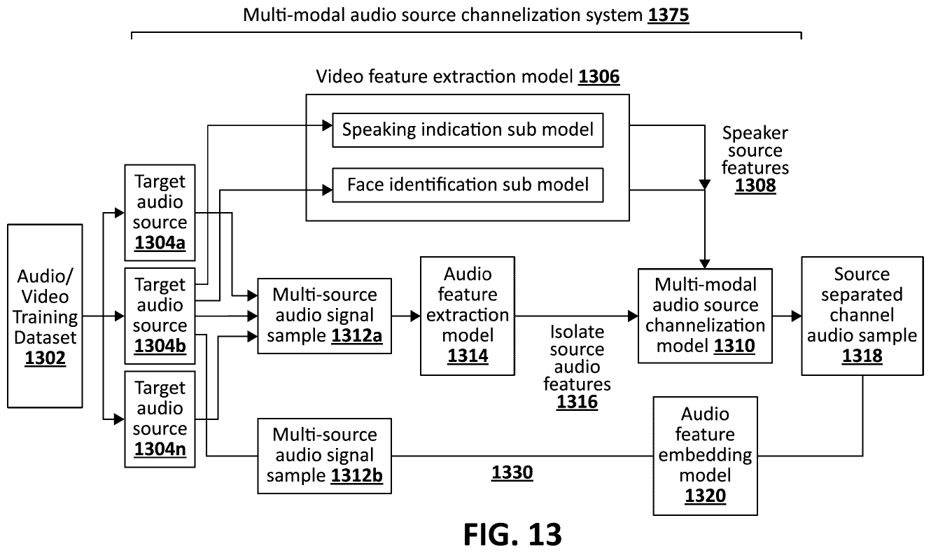

Notably, unlike some undesirable systems, various embodiments of multi-modal audio source channelization systems discussed herein do not necessarily require precise positioning of audio capture devices 103a-m and video capture devices 102a-n as the disclosed multi-modal audio source channelization systems are configured to learn and adapt to their particular audio environments. Such learning and training is facilitated by the model training operations discussed below in connection with FIG. 13.

FIG. 1 depicts an example multi-modal audio source channelization system 175 that is comprised of a video feature extraction model 104, an audio feature extraction model 105, and one or more multi-modal audio source channelization models 108a-b. The depicted multi-modal audio source channelization models 108a-b are configured to directly generate source separated channel audio samples 109a-b based on one or more audio-based features (e.g., isolate source audio features 107a-b) and one or video-based features (e.g., speaker source features 106a-b) that are generated by the audio feature extraction model 105 and the video feature extraction model 104, respectively. In another example (not shown), multi-modal audio source channelization models are configured to indirectly generate a source separated channel audio sample by first generating a source separated channel audio mask that is then applied to a multi-source audio signal sample to produce the source separated channel audio sample.

Example multi-modal audio source channelization systems 175 as discussed herein may include one multi-modal audio source channelization model for each respective target audio source. For example, multi-modal audio source channelization model 108a may be configured to channelize audio associated with target audio source 101a while multi-modal audio source channelization model 108b may be configured to channelize audio associated with target audio source 101b. Similarly, two additional multi-modal audio source channelization models (not shown) may be configured to channelize audio associated with each of target audio sources 101c-d respectively.

Multi-modal audio source channelization systems as discussed herein may be implemented as part of a digital signal processing apparatus, and/or as software, or a software plugin, that is configured for execution on a laptop, PC, or other computing device. Multi-modal audio source channelization systems can further be incorporated into software that is configured for automatically processing multi-source audio signal samples from one or more audio capture devices and one or more video capture devices that form part of an audio-conferencing system, a video conferencing system, an augmented reality system, a virtual reality system, and the like.

The audio capture devices 103a-m depicted in FIG. 1 are configured to output a multi-source audio signal sample. The term “multi-source audio signal sample” refers to audio data or an audio data stream or portion thereof that comprises two or more target audio sources and is capable of being transmitted, received, processed, and/or stored in accordance with solutions of the present disclosure. The term multi-source audio signal sample may also refer to a defined portion of a multi-source audio signal (e.g., streaming multi-source audio data) that is made available for digital signal processing and channelization operations. Such multi-source audio signal samples are time domain signals that represent one or more portions of the multi-source audio signal based on amplitude and time.

A multi-source audio signal sample may be embodied as a data chunk having a size ranging from 2.5 milliseconds to 200 milliseconds. For example, a multi-source audio signal sample may be configured as a 30 millisecond data chunk of a multi-source audio signal stream. In other embodiments, the multi-source audio signal sample may be configured as a 2.5 millisecond data chunk, a 50 millisecond data chunk, or a 150 millisecond data chunk of a multi-source audio signal stream.

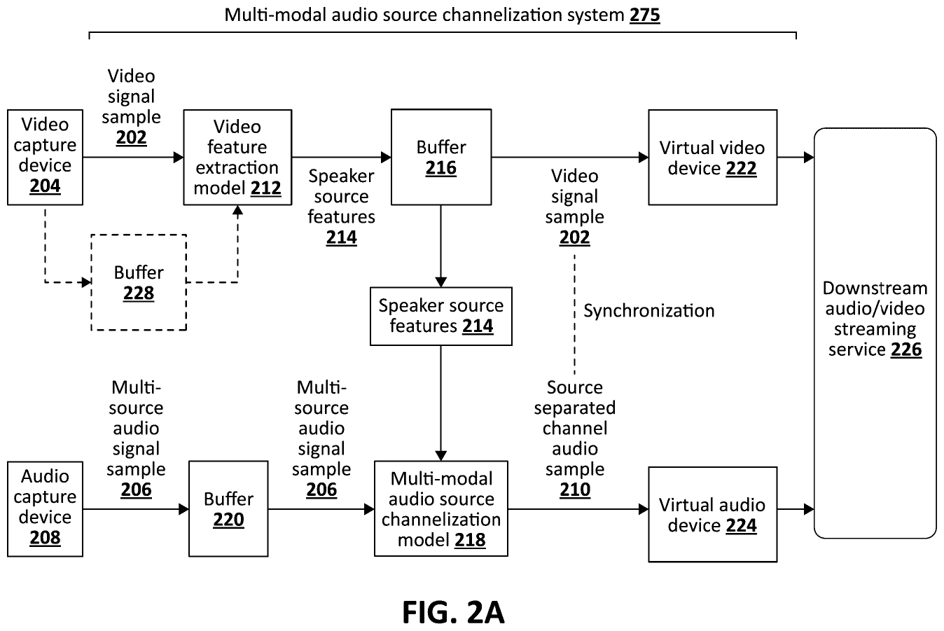

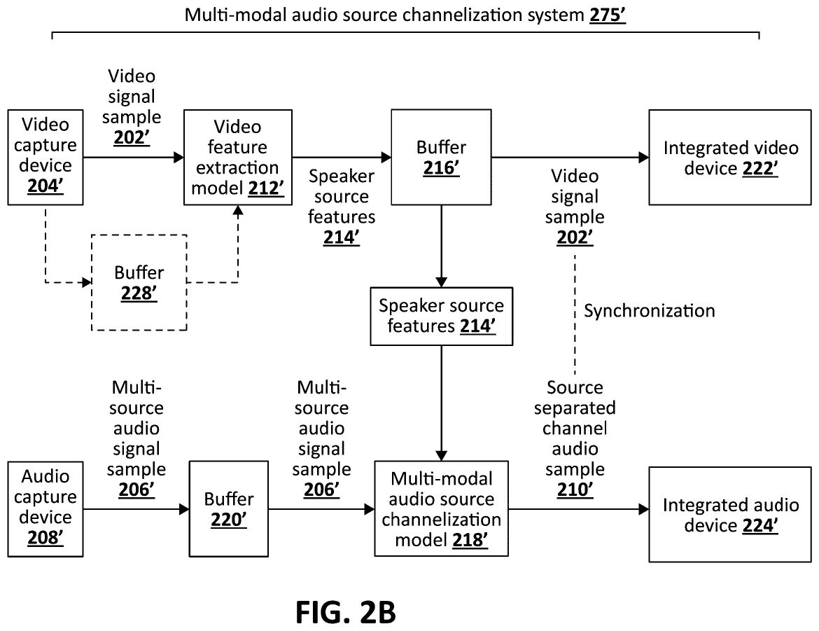

The multi-source audio signal sample may be embodied as a data chunk that is selected based on a common minimum processing size for the multi-source audio signal sample and the video signal sample. For example, if a video signal sample has a minimum data chunk size corresponding to 25 frames per second (˜40 milliseconds), then the smallest multi-source audio signal sample data chunk should also be approximately 40 milliseconds. Buffers of the type described in FIGS. 2A and 2B may be used to address synchronization of audio and video processing in circumstances where video and audio signal sample sizes differ.

A deep neural network (DNN) model (e.g., a multi-modal audio source channelization model) may be provided with input features related to multiple window sizes of a multi-source audio signal sample. A multi-source audio signal sample may be a mixed multi-source audio signal sample that includes speech and noise (e.g., stationary or non-stationary noise). The example multi-source audio signal sample generated from the depicted target audio sources 101a-d includes speech of two simultaneous speakers (i.e., target audio sources 101a and 101b) and stationary or non-stationary noise produced from target audio source 101d. Such overlapping speech and noise is difficult or impossible for various undesirable approaches to audio source separation to handle but is readily managed by various solutions disclosed herein.

In some example solutions, multi-source audio signal samples may include target audio source spatial data. For example, the multi-source audio signal sample may include signal-to-noise ratio range data, temperature data, position data, orientation data, reverberation data, time difference of arrival data, binaural data, audio capture device location data, or the like. Such target audio source spatial data may be embodied as metadata appended to the multi-source audio signal sample.

In some example systems, the multi-source audio signal sample is provided by an automixer (e.g., an automatic microphone mixer) that processes one or more audio channels associated with one or more microphones (e.g., one or more audio capture devices). The multi-source audio signal sample may be generated by a single microphone, by an array microphone, or by multiple other audio capture devices.

The multi-source audio signal sample generated by audio capture devices 103a-m are output to an audio feature extraction model 105 that is trained to generate one or more isolate source audio features 107a-b. Audio feature extraction model 105 and isolate source audio features 107a-b are shown in dotted lines in FIG. 1 because, in some examples, a multi-modal audio source channelization model 108b may optionally include neural network layers that perform the functionality (e.g., generation of isolate source audio features 107a-b) of the depicted audio feature extraction model 105 as discussed below in greater detail. In other examples, the multi-source audio signal sample is used as input for a source spatialization model (not shown) that is trained to generate isolate source spatial input data.

The term “audio feature extraction model” refers to a data construct that describes defined operations of a machine learning model (e.g., a DNN or portion thereof) that is configured to extract one or more isolate source audio features based on a multi-source audio signal sample. The audio feature extraction model comprises one or more neural network layers (e.g., one or more fully-connected neural network layers) that are configured to process a multi-source audio signal sample to generate one or more isolate source audio features that are associated with or estimated to be associated with a target audio source identified within the multi-source audio signal sample. An audio feature extraction model may be further configured to separate the multi-source audio signal sample and identify isolate source audio features or a set of isolate source audio features for multiple target audio sources.

The audio feature extraction model illustrated in FIG. 1 may be configured as a part of a multi-modal audio source channelization model (e.g., multi-modal audio source channelization model 108a-b). Although not depicted as such, the audio feature extraction model may form a subset of layers (e.g., one or more fully-connected convolutional neural network layers) or sub model of the multi-modal audio source channelization model. In the depicted example, the audio feature extraction model is a distinct model positioned as an intermediary between the audio capture device 103a-m and the multi-modal audio source channelization model 108a-b.

In some solutions, source separation may occur serially before feature extraction. That is, target audio sources of a multi-source audio signal sample may be identified or isolated, and then the audio feature extraction model may be applied to generate, based on source separated audio of the target audio sources, one or more isolate source audio features associated with each respective target audio source. In still other solutions, the audio feature extraction model is configured to transform the multi-source audio signal sample into isolate source audio features that describe or are otherwise associated with the respective target audio sources without first separating the multi-source audio signal sample into target audio source audio samples.

In other solutions, source classification may occur serially before feature extraction. That is, target audio sources of a multi-source audio signal sample may be isolated and classified to identify an isolate source audio category (e.g., speaker, noise source, etc.) as discussed in greater detail below. The audio feature extraction model may then be applied to generate, based on source separated audio of the target audio sources and any associated isolate source audio categories, one or more isolate source audio features associated with each respective target audio source. In still other solutions, the audio feature extraction model is configured to transform the multi-source audio signal sample into isolate source audio features that describe or are otherwise associated with the respective target audio sources without first separating and classifying the multi-source audio signal sample into target audio source audio samples of particular isolate source audio categories.

Operations of the audio feature extraction model may be performed by an audio signal processing apparatus. The audio feature extraction model may be configured to receive one or more multi-source audio signal samples as input and then to generate one or more isolate source audio features. The term “isolate source audio feature” refers to one or more features extracted by an audio feature extraction model.

An isolate source audio feature can be a set of features (e.g., embeddings, encodings, parameters, coefficients, matrices, vectors, transformations, representations, or the like) that describe a multi-source audio signal sample. In some embodiments, an isolate source audio feature can be a set of features that describe a target audio source identified within a multi-source audio signal sample. For instance, an isolate source audio feature may include a MelSpectrum, Log-MelSpectrum, Mel-frequency cepstral coefficients (MFCC), Mel-frequency cepstrum, Short-time Fourier transform (STFT), waveform, Residual Vector Quantizer (RVQ), transfer function features, delay of arrival features, timbre features, audio spectrum features, magnitude features, phase features, pitch features, harmonic features, audio separation modeling features, time-domain audio separation network (TasNet) features, performance features, performance sequencer features, tempo features, time signature features, mask features, a cochleargram representation, a cochlea neural transformation, or the like.

Each target audio source of a multi-source audio signal sample is associated with one or more isolate source audio features, which are aspects or characteristics of the target audio source. Isolate source audio features are used as input for a multi-modal audio source channelization model to generate a source separated channel audio sample as discussed in greater detail below.

The video capture devices 102a-n depicted in FIG. 1 are configured to output a video signal sample. The term “video signal sample” refers to a video data or a video data stream or portion thereof that includes one or more target audio sources and is capable of being transmitted, received, processed and/or stored in accordance with embodiments of the present disclosure. In some example solutions, the term video signal sample refers to a defined portion of a video signal (e.g., streaming video data) that is made available for image processing. The video signal sample can be an analog signal, digital signal, or the like.

A video signal sample may be defined by a framerate and embodied as a data chunk (i.e., a single frame) having a size ranging from 2.5 milliseconds to 200 milliseconds. For example, a video signal sample may be configured as a 30 millisecond data chunk of a video signal stream. In other examples, the video signal sample may be configured as a 2.5 millisecond data chunk, a 50 milliseconds data chunk, or a 150 millisecond data chunk of a video signal stream.

The multi-source audio signal sample may be configured as a data chunk having a size that is selected relative to the framerate of the video signal sample (e.g., 25 frames per second). For example, if the framerate of a video signal sample is 25 frames per second, the corresponding multi-source audio signal sample may be configured as a 40 millisecond data chunk. Alternatively, if the framerate of a video signal sample is 10 frames per second, the corresponding multi-source audio signal sample may be configured as a 100 millisecond data chunk.

The video signal sample discussed in connection with FIG. 1 is provided by two or more video capture devices 102a-n. The video signal sample may also be a multi-feed video signal sample. For example, the video signal sample may be assembled as a multi-feed video signal sample based on two or more video signal samples captured by the two or more video capture devices 102a-n. Such multi-feed video signal samples may enable best or differing view samples to be used as input for a video feature extraction model (e.g., video feature extraction model 104) that is configured to generate speaker source features. In some examples, two or more video signal samples captured by two or more video capture devices (e.g., two or more video channels) may be routed to distinct feature extraction models to generate respective speaker source features that are later consolidated.

The video signal sample produced by the video capture devices 102a-n of FIG. 1 is output to a video feature extraction model 104. The term “video feature extraction model” refers to a data construct that describes defined operations of a machine learning model (e.g., a DNN or portion thereof) that is configured to extract one or more speaker source features when applied to a video signal sample.

The term “speaker source feature” refers to one or more features extracted by a video feature extraction model. A speaker source feature can be a set of features (e.g., embeddings, encodings, parameters, coefficients, matrices, vectors, transformations, representations, or the like) that describe a target audio source (e.g., a target speaker) and/or area of interest identified within a video signal sample. Speaker source features may be extracted from one or more video signal samples and/or multi-feed video signal samples. For instance, a speaker source feature may include a histogram of oriented gradients, local binary pattern, motion vectors, spatiotemporal interest points, scale-invariant feature transform, or the like.

Speaker source features may be used to represent speaking indications associated with human facial images or human gestures taken from video data. For example, one or more speaker source features may describe or indicate lip movement, facial movement, eye movement, gaze detection, gaze direction detection, body pose and/or gesture detection, hand gesture detection, or the like. Each identified target audio source (e.g., a target speaker) or area of interest within a video signal sample may be associated with one or more speaker source features, which are aspects or characteristics of the target audio source or area of interest. Like isolate source audio features discussed above in connection with the audio feature extraction model, speaker source features are used as input for a multi-modal audio source channelization model to generate a source separated channel audio sample.

The term “speaking indications” refers to one or more visually observable or video detectable aspects or characteristics exhibited by an individual (e.g., a target audio source) when speaking. In some embodiments, speaking indications include image data associated with lip movement. For example, when an individual is speaking, such individual's lips and surrounding facial region will move accordingly. Particular words spoken may be associated with particular lip movements that are identifiably distinct from other lip movements associated with other words.

In some embodiments, speaking indications also include image data associated with hand gestures or body gestures. For example, when an individual is speaking, they may move their hands in particular patterns and gestures that are associated with speaking or, more simply, to emphasize or punctuate verbal speech. In another example, when an individual is speaking, they may assume particular body gestures and/or poses that are associated with speaking. For example, individuals in a classroom or meeting might (1) raise their hand (e.g., example gesture) or (2) stand from a seated position (e.g., example pose) to be recognized prior to or in association with speaking. Thus, hand raising gestures and standing gestures may be speaking indications as discussed herein.

Speaking indications may be defined, trained, or enhanced using image data of individuals that are not speaking. For example, when an individual is not speaking, their lips and surrounding facial region may not be moving. In another example, when an individual is not speaking, their hands may not be moving, they may be seated, or their hand may not be raised.

In some circumstances, a video feature extraction model includes a speaking indication sub model or a subset of layers (e.g., one or more fully-connected convolutional neural network layers) configured to generate one or more speaker source features. The speaking indication sub model is configured to generate one or more speaker source features informed by, or based on, one or more regions of interest (e.g., one or more regions defined by virtual bounding boxes applied to a video signal sample). The speaking indication sub model may be configured to generate speaker source features associated with speaking indications referenced above. Speaker source features, including lip-based features, allow various solutions disclosed herein to provide improved source channelization and source separation compared with other undesirable audio source separation systems and models that are not trained using such features.

In some circumstances, a video feature extraction model includes a face identification sub model or a subset of layers (e.g., one or more fully-connected convolutional neural network layers) configured to provide a face identification indication or otherwise to generate speaker source features. The face identification sub model may generate one or more speaker source features informed by, or based on, one or more regions of interest (e.g., one or more regions defined by virtual bounding boxes applied to a video signal sample). The face identification sub model may be configured to generate speaker source features associated with the identity of a target audio source. For example, the face identification sub model may perform one or more facial recognition operations to generate one or more speaker source features that identify a target audio source (e.g., an individual depicted in the video signal sample) by a unique identifier (e.g., a face identification indication). In some examples, the face identification sub model may be configured to generate speaker source features that include a face embedding data structure that uniquely identifies a target audio source.

The depicted video feature extraction model 104 comprises one or more neural network layers (e.g., one or more fully-connected neural network layers) that are configured to process a video signal sample to generate one or more speaker source features 106a-b. Notably, the video signal sample might include images of humans speaking, humans who are not speaking, electrical fans, HVAC systems, audio speakers, televisions, or other audio sources. The video feature extraction model 104 is configured to extract speaker source features associated with a target audio source based on training data that includes target audio sources and other audio sources.

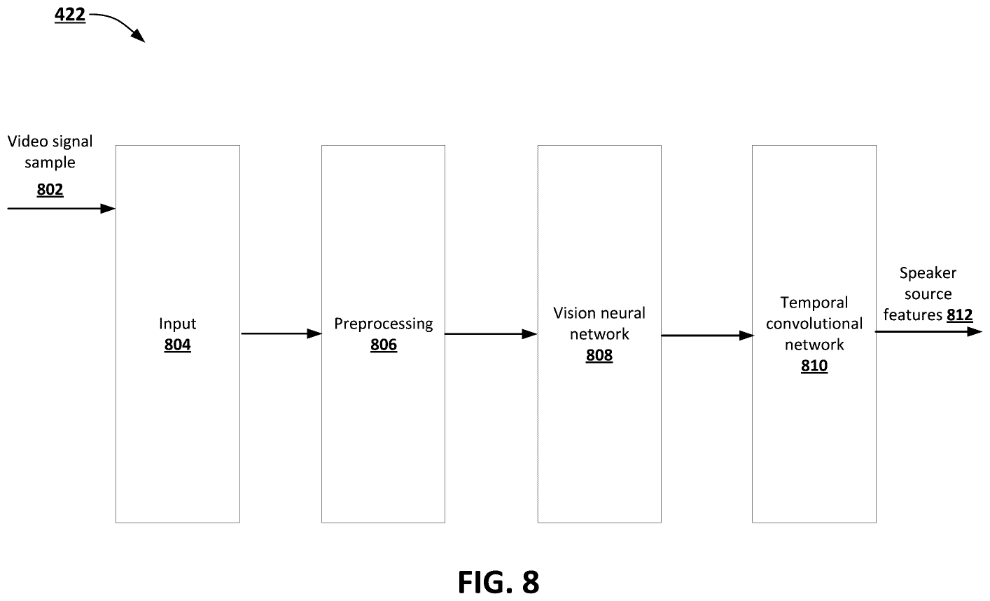

In some circumstances, the video feature extraction model is configured to apply source separation or source identification operations serially before feature extraction. Source separation or source identification may be performed automatically using computer vision techniques. In some examples, virtual bounding boxes, such as those depicted in FIG. 8, may be created by image processing software and defined around images of audio sources or areas of interest within video signal samples that are used for feature extraction model training and multi-modal audio source channelization model training. For example, bounding boxes may be defined around an individual's body, head, face, mouth, lips, hands, or the like. In other examples, bounding boxes may be defined around HVAC vents, telephones, squeaky chairs, or other noise sources. Bounding boxes may also be used to define regions within a video signal sample that inform the speaking indication sub model, the face identification sub model, and training operations associated with such sub models.

It should be noted that, in various example solutions, video feature extraction operations conducted by the video feature extraction model 104 are designed to identify video queues or indicators of when a speaker is speaking or to otherwise correlate images of a target audio source to a particular audio signal sample. This stands in contrast to other video feature extraction models (e.g., transcription models) that might be applied to images of speakers as such models are typically trained to identify queues or indicators of what is being said (i.e., in support of transcript generating services and the like).

The video feature extraction model 104 depicted in FIG. 1 is configured to receive one or more video signal samples from the one or more video capture devices 102a-n and extract one or more speaker source features 106a-b corresponding to one or more target audio source 101a-d. For example, video capture device 102a may output video signal samples associated with target audio source 101a-d to video feature extraction model 104.

Video feature extraction model 104 is configured to generate one or more speaker source features 106a associated with target audio source 101a and one or more speaker source features 106b associated with target audio source 101b. The speaker source features 106a-b and isolate source audio features 107a-b are output to one or more multi-modal audio source channelization models 108a-b to generate one or more source separated channel audio samples 109a-b.

The term “multi-modal audio source channelization model” refers to a data construct that describes defined operations of a machine learning model (e.g., a DNN) that is configured to generate a source separated channel audio sample based on one or more of isolate source audio features and one or more speaker source features. Notably, the multi-modal audio source channelization models discussed herein are “multi-modal” in that they are trained based on audio data (e.g., isolate source features) and image data (e.g., speaker source features). In various embodiments discussed herein, the multi-modal audio source channelization model is trained based on audio data and video data of audio sources within an environment or multiple environments.

Multi-modal audio source channelization models are configured to generate source separated channel audio samples and/or source separated channel audio masks based on one or more of isolate source audio features, one or more speaker source features, isolate source spatial input data, one or more isolate source audio categories, and one or more isolate source audio identities. Multi-modal audio source channelization models may comprise one or more neural network layers (e.g., one or more fully-connected neural network layers) that are configured to process one or more inputs to generate one or more source separated channel audio samples and/or source separated channel audio masks. Multi-modal audio source channelization models are configured to distinguish among target audio sources in a manner that generates, either directly or indirectly, predicted source separated channel audio samples that contain isolated audio emitted by respective target audio sources.

In some examples, one or more neural network layers of a multi-modal audio source channelization model define an audio feature extraction model or sub model. For example, one or more layers of a multi-modal audio source channelization model may be configured to receive a multi-source audio signal sample and perform operations described above with respect to the audio feature extraction model 105 of FIG. 1 (e.g., generate one or more isolate source audio features).

Multi-modal audio source channelization models are also configured to dynamically assess various inputs. For example, a multi-modal audio source channelization model may apply parameters to weight one or more inputs differently. The multi-modal audio source channelization model may use, for example, a greater weight for an isolate source audio feature and a lesser weight for a speaker source feature in a manner that causes the output to be dependent on the isolate source audio feature but independent or nearly independent of the speaker source feature. In another example, the multi-modal audio source channelization model may use a first weight for an isolate source audio feature and another weight for a speaker source feature in a manner that causes the output to be codependent on the isolate source audio feature and speaker source feature.

In still other examples, the multi-modal audio source channelization model may apply a first weight for an isolate source audio feature, another weight for a speaker source feature, another weight for an isolate source audio category, another weight for isolate source audio identities, and yet another weight for isolate source spatial input data in a manner that causes the output to be codependent on the isolate source audio feature, speaker source feature, isolate source audio category, isolate source audio identities, and isolate source spatial input data. In yet another example, the multi-modal audio source channelization model is configured to dynamically engage one or more models associated with its various inputs as described in greater detail below.

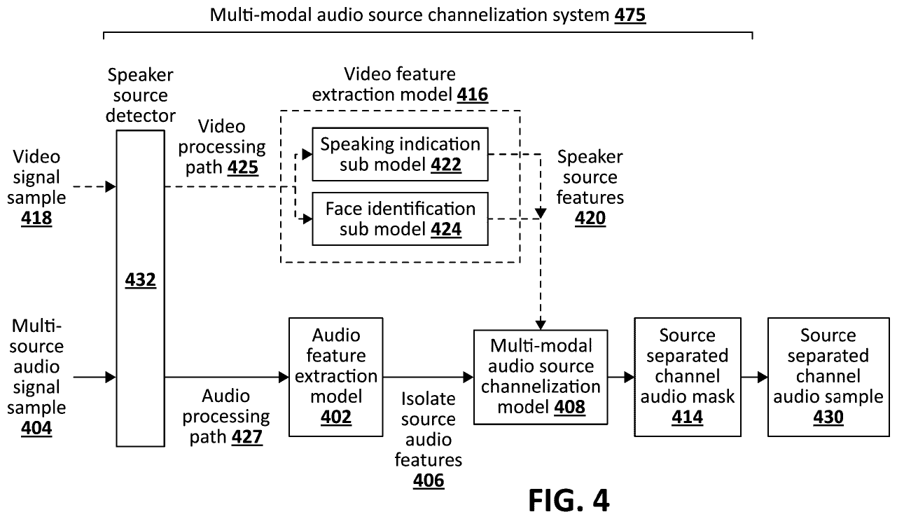

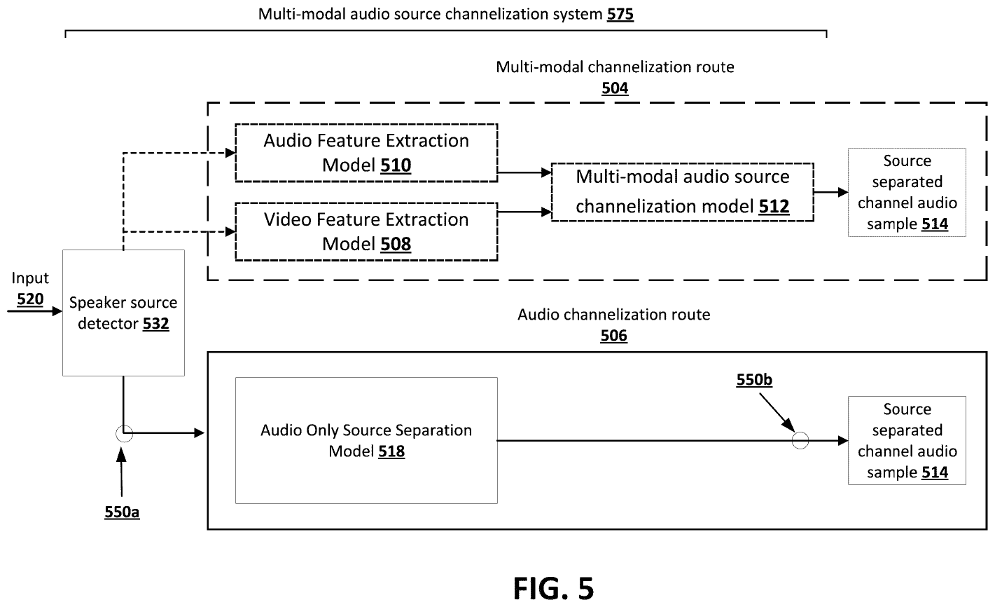

While various example solutions discussed herein are enhanced by the use of audio and video data, they are not necessarily crippled if the video data were lost. For example, example solutions discussed in connection with FIGS. 4 and 5 are configured to continue to operate independently based on audio data if a target audio source is lost within a video signal sample. This might occur, for example, in a scenario in which a target audio source (e.g., a target speaker) becomes obscured or hidden (e.g., perhaps walking behind a pillar, becoming positioned so that a speaker's face is obstructed behind non-speaking individuals, etc.) relative to a video capture device. In such examples, the video feature extraction model would not be able to extract speaker source features from the associated video signal sample during the particular time window that the target audio source is absent from the video signal sample. Example multi-modal audio source channelization models discussed herein may be configured to rely more heavily on isolate source audio features to generate a source separated channel audio sample in such circumstances.

Multi-modal audio source channelization models discussed herein may be generative adversarial networks (GANs). An example GAN may receive multiple inputs during training including features (e.g., isolate source audio features, speaker source features, isolate source spatial input data), the original audio (e.g., multi-source audio signal sample) and video (e.g., video signal sample) that was used to create those features, and other real or actual audio (e.g., target audio source) as ground truth data for a discriminator to use to estimate the accuracy of generated audio. In other examples, multi-modal audio source channelization models may not be GANs.

Example multi-modal audio source channelization models may be a convolutional DNN configured in a U-Net architecture. In still other examples, the multi-modal audio source channelization model can include an encoder/decoder network structure with skip connections.

The multi-modal audio source channelization model may take multiple inputs of one domain (e.g., isolate source audio features, speaker source features, isolate source spatial input data, isolate source audio categories, isolate source audio identities) and transform them to another domain (e.g., source separated channel audio sample, source separated channel audio mask).

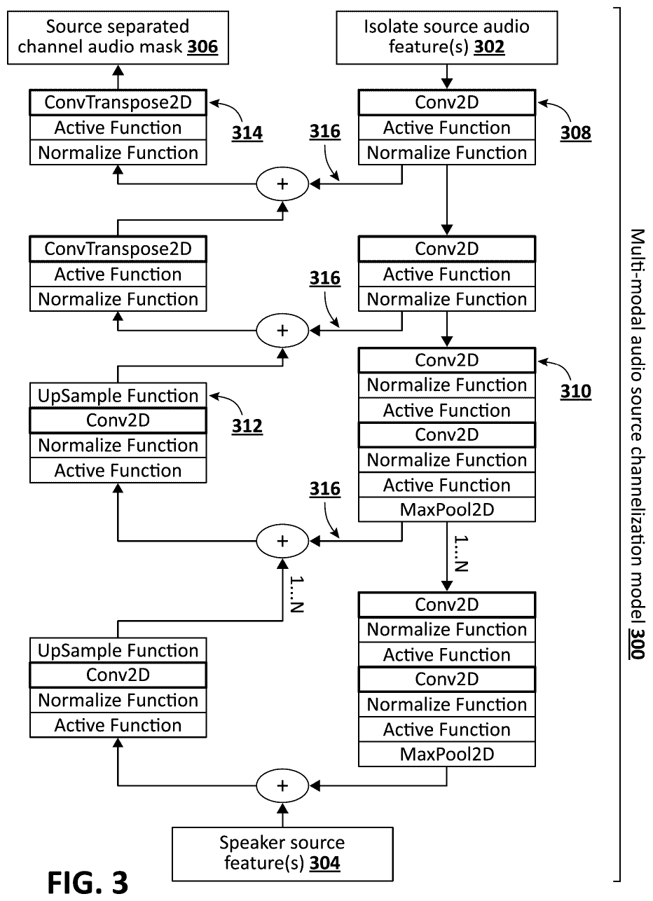

The multi-modal audio source channelization model may be configured to output actual channelized audio (e.g., source separated channel audio sample) or a mask (e.g., source separated channel audio mask) that can be applied to an audio sample to create channelized audio. Although the multi-modal audio source channelization model is depicted in some examples to directly output a source separated channel audio sample (e.g., FIGS. 1, 2, 5-6) or a source separated channel audio mask (e.g., FIGS. 3, 4), it should be appreciated that the various multi-modal audio source channelization models may be configured to directly output either a source separated channel audio sample or a source separated channel audio mask without limitation. In each case, the output of the multi-modal audio source channelization model is determined from the audio data (e.g., isolate source features) and video data (e.g., speaker source features).

Operations of the multi-modal audio source channelization model may be performed by an audio signal processing apparatus. Various example multi-modal audio source channelization models are configured to receive one or more of isolate source audio features, one or more speaker source features, and optionally receive one or more isolate source audio categories, one or more isolate source audio identities, and/or isolate source spatial input data as input to generate a source separated channel audio sample or a source separated channel audio mask, which is then applied to multi-source audio signal sample to generate a source separated channel audio sample.

The term “source separated channel audio sample” refers to a modified version (e.g., a channelized version) of a multi-source audio signal sample that comprises audio data or an audio data stream that is associated with a target audio source and that is capable of being transmitted, received, processed, and/or stored in accordance with embodiments of the present disclosure. The source separated channel audio sample is generated by a multi-modal audio source channelization model either indirectly (using a mask) or directly. Source separated channel audio samples are the output data structures or streams that enable each target audio source identified within a multi-source audio signal sample to be isolated as respective channels of audio.

The source separated channel audio sample is generated by the multi-modal audio source channelization model based on one or more of isolate source audio features and one or more speaker source features. In some examples, the source separated channel audio sample is generated by the multi-modal audio source channelization model based on one or more of isolate source audio features, one or more speaker source features, one or more isolate source audio categories, one or more isolate source audio identities, and isolate source spatial input data. The source separated channel audio sample may include spatialization information associated with the respective target audio source. For example, the source separated channel audio sample may include isolate source spatial output data. In some embodiments, the source separated channel audio sample is output to one or more audio output devices (e.g., one or more speakers or transmitters).

The term “source separated channel audio mask” refers to an output mask (e.g., time frequency mask, spectrogram mask, etc.) of a multi-source audio signal sample that is configured to produce a source separated channel audio sample when applied to a multi-source audio signal sample. The source separated channel audio mask can provide a prediction for audio sources, noise, reverberations, and other undesirable audio artifacts that may be present in the multi-source audio signal sample, but which are to be isolated, removed, or nulled when producing the source separated channel audio sample.

In some examples, the source separated channel audio mask is a time-frequency mask that represents a masking applied to a multi-source audio signal sample based on frequency and time. The source separated channel audio mask may be formatted as a spectrogram that provides a set of values ranging from 0 to 1 for the respective portions of the multi-source audio signal sample.

In various solutions, multiple source separated channel audio masks are generated by a multi-modal audio source channelization model in order to create several different source separated channel audio samples (e.g., one for each target audio source). Each of the source separated channel audio masks may be applied to the multi-source audio signal sample to produce discrete source separated channel audio samples that are output as respective channels of audio.

A source separated channel audio mask is generated by the multi-modal audio source channelization model based on one or more of isolate source audio features and one or more speaker source features. In some examples, a source separated channel audio mask is generated by the multi-modal audio source channelization model based on one or more of isolate source audio features, one or more speaker source features, one or more isolate source audio categories, one or more isolate source audio identities, and isolate source spatial input data. The source separated channel audio mask may be applied to a multi-source audio signal sample or isolate source audio features to generate a source separated channel audio sample. For instance, the multi-modal audio source channelization model may apply a source separated channel audio mask to a multi-source audio signal sample or isolate source audio feature (e.g., short-time Fourier transform) to generate a source separated channel audio sample.

The term “audio output device” refers to a device that receives an audio signal for transmission, playback and/or broadcasting. Examples of audio output devices include speakers that are configured to convert electrical signals into sound waves, or the like. Other examples of audio output devices include wireless audio transmitters that are configured to transmit a signal, carrier wave, or the like towards one or more audio receivers.

The multi-modal audio source channelization models 108a-b depicted in FIG. 1 receive one or more isolate source audio features 107a-b and one or more speaker source features 106a-b associated with target audio sources 101a-d and generates one or more source separated channel audio samples 109a-b. Each source separated channel audio sample 109a-b includes audio associated with only one of a respective target audio source 101a-d. For example, source separated channel audio sample 109a may include audio associated with only target audio source 101a while source separated channel audio sample 109b may include audio associated with only target audio source 101b.

FIG. 2A depicts an example schematic flow diagram of operations performed in real time or near real time by an example multi-modal audio source channelization system 275 in accordance with one or more solutions disclosed herein. The depicted multi-modal audio source channelization system 275 is configured to receive a video signal sample 202 from video capture device 204 and receive a multi-source audio signal sample 206 from audio capture device 208 in order to generate one or more source separated channel audio samples 210.

Multi-modal audio source channelization system 275 includes a video feature extraction model 212 that is configured to receive the video signal sample 202 to generate one or more speaker source features 214. The one or more speaker source features 214 are output to buffer 216, which is configured to store and delay the one or more speaker source features 214 for a time interval before outputting such speaker source features 214 to the multi-modal audio source channelization model 218. The time interval associated with the buffer 216 may be a static or dynamic value, range of values, or the like. For example, buffer 216 may temporarily store a signal for 1 millisecond, 10 milliseconds, 100 milliseconds, 500 milliseconds, 1 second, and so on.

Similarly, buffer 220 is configured to receive multi-source audio signal sample 206 and to store and delay the multi-source audio signal sample 206 for a time interval before outputting the multi-source audio signal sample 206 to multi-modal audio source channelization model 218. The buffer 216 in the video signal sample processing flow and the buffer 220 in the multi-source audio signal sample processing flow can collectively used to calibrate or synchronize respective audio and video inputs to the multi-modal audio source channelization model 218 and other downstream processes, devices, or services.

Video capture device 204 may be configured to output the video signal sample 202 to optional buffer 228, shown in dotted lines, which is configured to store and delay the video signal sample 202 for a time interval before outputting the video signal sample 202 to the video feature extraction model 212. Delaying the video signal sample 202 may be useful in some examples to align or correlate audio and video inputs prior to feature extraction.

The depicted multi-modal audio source channelization model 218 is configured to receive the one or more speaker source features 214 from buffer 216 and multi-source audio signal sample 206 from buffer 220 to directly generate one or more source separated channel audio samples 210. Notably, multi-modal audio source channelization model 218 includes one or more neural network layers that define an audio feature extraction model or sub model and, thus, a separate audio feature extraction model is not shown upstream of buffer 220.

The depicted multi-modal audio source channelization model 218 is configured to process received signals (e.g., speaker source features, isolate source spatial input data, multi-source audio signal samples, etc.) in less time than the window sizes selected for the incoming data chunks, thereby effectively achieving real time processing. For example, both speaker source features 214 and multi-source audio signal sample 206 may define 40 millisecond window size data chunks. Thus, the depicted multi-modal audio source channelization model 218 is desirably configured to process the received signals and generate a source separated channel audio sample 210 in approximately 30 milliseconds or less.

FIG. 2A depicts a multi-modal audio source channelization system 275 including a virtual video device 222 configured to receive video signal sample 202 from buffer 216 and a virtual audio device 224 configured to receive one or more source separated channel audio samples 210 from multi-modal audio source channelization model 218. The multi-modal audio source channelization system 275 is configured to correlate and synchronize the video signal sample 202 with the one or more source separated channel audio samples 210 provided to the virtual video device 222 and virtual audio device 224, respectively. The depicted virtual video device 222 and virtual audio device 224 are configured to output the respective video signal sample 202 and one or more source separated channel audio samples 210 to downstream audio/video streaming service 226 (e.g., Microsoft Teams, BlueJeans, Zoom, etc.).

The depicted multi-modal audio source channelization system 275 is configured to run on a host device (e.g., a computer) that is connected to the Internet to support output of channelized audio to a downstream audio/video streaming service 226. In other examples, the multi-modal audio source channelization system (not shown) may be configured to run on an input device (e.g., a video bar, a web camera, etc.) that does not support virtual devices (e.g., virtual video device 222 and virtual audio device 224) such as the video bar example discussed in connection with FIG. 2B below.

FIG. 2B illustrates an example schematic flow diagram of operations performed in real time or near real time by an example multi-modal audio source channelization system 275′ implemented on a video bar device in accordance with one or more solutions disclosed herein. The video bar device provides an integrated solution for video conferences and other applications by consolidating a camera, microphones, and speakers into a single device.

The depicted multi-modal audio source channelization system 275′ is configured to receive a video signal sample 202′ from video capture device 204′ and receive a multi-source audio signal sample 206′ from audio capture device 208′ to generate one or more source separated channel audio samples 210′. In this video bar embodiment, the video capture device 204′ and audio capture device 208′ are integrated camera and speaker components of the video bar, providing a compact and unified audio-visual input solution.

Multi-modal audio source channelization system 275′ includes a video feature extraction model 212′ that is configured to receive the video signal sample 202′ to generate one or more speaker source features 214′. The one or more speaker source features 214′ are output to buffer 216′, which is configured to store and delay the one or more speaker source features 214′ for a time interval before outputting such speaker source features 214′ to the multi-modal audio source channelization model 218′. The time interval associated with the buffer 216′ may be a static or dynamic value, range of values, or the like.

Similarly, buffer 220′ is configured to receive multi-source audio signal sample 206′ and to store and delay the multi-source audio signal sample 206′ for a time interval before outputting the multi-source audio signal sample 206′ to multi-modal audio source channelization model 218′. The buffer 216′ in the video signal sample processing flow and the buffer 220′ in the multi-source audio signal sample processing flow can collectively be used to calibrate or synchronize respective audio and video inputs to the multi-modal audio source channelization model 218′ and other downstream processes within the video bar device.

Video capture device 204′ may be configured to output the video signal sample 202′ to optional buffer 228′, shown in dotted lines, which is configured to store and delay the video signal sample 202′ for a time interval before outputting the video signal sample 202′ to the video feature extraction model 212′. Delaying the video signal sample 202′ may be useful in some examples to align or correlate audio and video inputs prior to feature extraction.

The depicted multi-modal audio source channelization model 218′ is configured to receive the one or more speaker source features 214′ from buffer 216′ and multi-source audio signal sample 206′ from buffer 220′ to directly generate one or more source separated channel audio samples 210′. Notably, multi-modal audio source channelization model 218′ includes one or more neural network layers that define an audio feature extraction model or sub model and, thus, a separate audio feature extraction model is not shown upstream of buffer 220′.

The depicted multi-modal audio source channelization model 218′ is configured to process received signals (e.g., speaker source features, isolate source spatial input data, multi-source audio signal samples, etc.) in less time than the window sizes selected for the incoming data chunks, thereby effectively achieving real time processing. For example, both speaker source features 214′ and multi-source audio signal sample 206′ may define 40 millisecond window size data chunks. Thus, the depicted multi-modal audio source channelization model 218′ is desirably configured to process the received signals and generate a source separated channel audio sample 210′ in approximately 30 milliseconds or less.

In the depicted video bar embodiment, the source separated channel audio samples 210′ may be directly output to an integrated audio device 224′ (e.g., integrated speakers) within the video bar device, providing immediate audio in the local video bar environment. The video signal sample 202′ is output to an integrated video device 222′ (e.g., a video monitor or display) providing immediate video in the local sound bar environment that is closely calibrated to the channelized audio output. Alternatively or additionally, the source separated channel audio samples 210′ may be transmitted to remote participants via built-in communication interfaces in the video bar, enabling high-quality, channelized audio in video conferencing scenarios.

The integrated nature of the depicted video bar embodiment allows for precise calibration and synchronization between the video and audio components, potentially improving the accuracy of the multi-modal audio source channelization system 275′. Furthermore, the compact form factor of the depicted video bar embodiment may necessitate optimized processing algorithms to handle potential challenges such as increased audio reverberation or limited camera field of view. While video bar embodiment is discussed herein for illustration purposes, one of ordinary skill in the art will readily appreciate that the inventive concepts herein described may be applied to other integrated audio/video devices such as web cameras, laptop computers, tablet computers, and the like.

The outputs of the multi-modal audio source channelization systems 275, 275′ depicted in FIGS. 2A and 2B may be provided via a software interface such as one or more software drivers. Outputs may also be provided via various connections or connector platforms such as USB, IP, ethernet, or the like.

Real time processing may enable multi-modal audio source channelization systems 275, 275′ as discussed herein to be used in live events. For example, multi-modal audio source channelization systems may enable separation of simultaneous singers and/or instruments in a concert venue to provide clean streams of target audio sources for better mixing and audio production. In a classroom or conference setting, example multi-modal audio source channelization systems may enable automatic activation or deactivation of audio channels based on speaking indications (e.g., an audience member standing or raising one's hand to ask a question) that are determined by the multi-modal audio source channelization systems thereby reducing the need for passing a microphone, and the like.

FIG. 3 depicts an example architecture for use within an example multi-modal audio source channelization model configured in accordance with one or more embodiments disclosed herein. In contrast to the multi-modal audio source channelization models shown in FIGS. 1, 2A, and 2B, example multi-modal audio source channelization model 300 is configured to receive isolate source audio features 302 and speaker source features 304 to a generate source separated channel audio mask 306 as shown.

Multi-modal audio source channelization model 300 includes a one or more convolutional blocks 308, convolutional blocks 310, up sample blocks 312, and transpose blocks 314 that are configured to process the isolate source audio features 302 and speaker source features 304 to generate the depicted source separated channel audio mask 306. One or more skip connectors 316 may be used to link two or more of the plurality of convolutional blocks 308, convolutional blocks 310, up sample blocks 312, and transpose blocks 314.

FIG. 4 depicts an example architecture for use within an example multi-modal audio source channelization system 475 configured in accordance with various example solutions disclosed herein. The depicted multi-modal audio source channelization system 475 is configured to continue to generate source separated channel audio samples 430 even in circumstances where the one or more video-based inputs (e.g., speaker source features 420) to the multi-modal audio source channelization model 408 are temporarily blocked. For example, in a case where a target audio source becomes obscured (e.g., a speaking individual walks out of a camera frame or steps behind a pillar or other obstruction) and speaker source features 420 associated with the target audio source can no longer be generated, the multi-modal audio source channelization system 475 remains configured to output one or more source separated channel audio samples 430 as described below.

The depicted multi-modal audio source channelization system 475 includes an audio feature extraction model 402 configured to receive multi-source audio signal sample 404 and output one or more isolate source audio features 406 to multi-modal audio source channelization model 408. The audio feature extraction model 402 is positioned along an audio processing path 427 as shown.

Multi-modal audio source channelization system 475 further includes video feature extraction model 416 configured to receive one or more video signal samples 418 and output one or more speaker source features 420 to the multi-modal audio source channelization model 408. The depicted video feature extraction model 416 includes a speaking indication sub model 422 and a face identification sub model 424. The video feature extraction model 416 is positioned along a video processing path 425 as shown. The video processing path 425 and each processing element contained therein are shown in dotted lines because they are optionally engaged as discussed below.

The depicted multi-modal audio source channelization system 475 includes a speaker source detector 432 that is positioned upstream of the video processing path 425 and the audio processing path 427. The speaker source detector 432 is configured to detect the presence or absence of target audio sources in any received video signal samples 418 and to engage or dis-engage the video processing path 425 accordingly. More particularly, the speaker source detector 432 may include a trained neural network model or sub-model that is configured to determine if video signal sample 418 includes target audio source related images that are sufficient to produce speaker source features 420. This may be referred to herein as the speaker source detector 432 determining if the video signal sample 418 satisfies a speaker source feature generation threshold.

In one example, when a speaker source detector 432 determines that a video signal sample includes target audio source images that are sufficient to produce speaker source features 420, the video processing path 425 is engaged and the multi-modal audio source channelization system 475 is configured to generate a source separated channel audio mask 414 that is configured to generate a source separated channel audio sample 430 based on audio data and video data. However, in circumstances where the speaker source detector 432 determines that a video signal sample does not include target audio source images that are sufficient to generate speaker source features 420, the video processing path 425 is disengaged and the multi-modal audio source channelization system 475 is configured to generate a source separated channel audio mask 414 that is configured to generate a source separated channel audio sample 430 based on audio data alone (i.e., without video data).

FIG. 5 depicts an example schematic flow diagram of example operations performed by another example multi-modal audio source channelization system 575. The depicted multi-modal audio source channelization system 575 includes a speaker source detector 532, a multi-modal channelization route 504, and an audio channelization route 506.

The depicted multi-modal channelization route 504 includes a video feature extraction model 508, an audio feature extraction model 510, and a multi-modal audio source channelization model 512 that are collectively configured to produce a source separated channel audio sample 514. While depicted in a simplified form for ease of discussion, the depicted multi-modal channelization route 504 may be configured to generate a source separated channel audio sample 514 or a source separated channel audio mask (not shown) in a manner described in connection with the example solutions discussed in connection with FIGS. 1, 2A, 2B.

The depicted audio channelization route 506 includes an audio only source separation model 518 that is configured to generate a source separated channel audio sample 514. While depicted in a simplified form for ease of discussion, the depicted audio channelization route 506 may be configured to employ an audio feature extraction model (not shown) to generate isolate source audio features that are input to the audio only source separation model 518 to generate a source separated channel audio sample 514 or a source separated channel audio mask (not shown). In this way, the audio channelization route 506 may be configured to the myriad of operations and functions described in connection with the example audio processing path 427 solution discussed in FIG. 4.

The depicted audio channelization route 506 includes an audio transformer 550a positioned upstream of the audio only source separation model 518 and an inverse audio transformer 550b positioned downstream of the audio only source separation model 518. The audio transformer 550a may be configured to transform a time domain signal into a frequency domain signal (e.g., referred to herein as a transformed multi-source audio signal sample) while the inverse audio transformer 550b may be configured to perform the inverse operation by transforming a frequency domain signal into a time domain signal. In some examples, the audio transformer 550a and inverse audio transformer 550b may be Fourier transforms (e.g., a fast Fourier transform, a short-time Fourier transform, etc.) and/or a discrete cosine transforms.

The speaker source detector 532 is configured to receive input 520 (e.g., one or more multi-source audio signal samples and/or video signal samples) and is configured to detect the presence or absence of target audio sources in any received video signal samples and to engage or dis-engage either the multi-modal channelization route 504 or the audio channelization route 506. The multi-modal channelization route 504 and each processing element contained therein are shown in dotted lines because they are optionally engaged as discussed below.

The depicted speaker source detector 532 is configured to detect the presence or absence of target audio sources in any received video signal samples that may be part of input 520 and to engage or dis-engage the multi-modal channelization route 504 accordingly. More particularly, the speaker source detector 532 may include a trained neural network model or sub-model that is configured to determine if input 520 includes target audio source related images that are sufficient to produce speaker source features that are needed to support operation of multi-modal audio source channelization model 512. Once again, this may be referred to herein as the speaker source detector 532 determining if the video signal samples of input 520 satisfy a speaker source feature generation threshold.

In one example, when a speaker source detector 532 determines that a video signal sample of input 520 includes target audio source images that are sufficient to produce speaker source features (i.e., speaker source feature generation threshold is satisfied), the multi-modal channelization route 504 is engaged and the multi-modal audio source channelization system 575 is configured to generate a source separated channel audio sample 514 based on audio data and video data. However, in circumstances where the speaker source detector 532 determines that a video signal sample of input 520 does not include target audio source images that are sufficient to generate speaker source features (i.e., speaker source feature generation threshold is not satisfied), the multi-modal channelization route 504 is disengaged and the audio channelization route 506 is engaged. Thus, the multi-modal audio source channelization system 575 is thereby configured to generate a source separated channel audio sample 514 based on audio data alone (i.e., without video data).

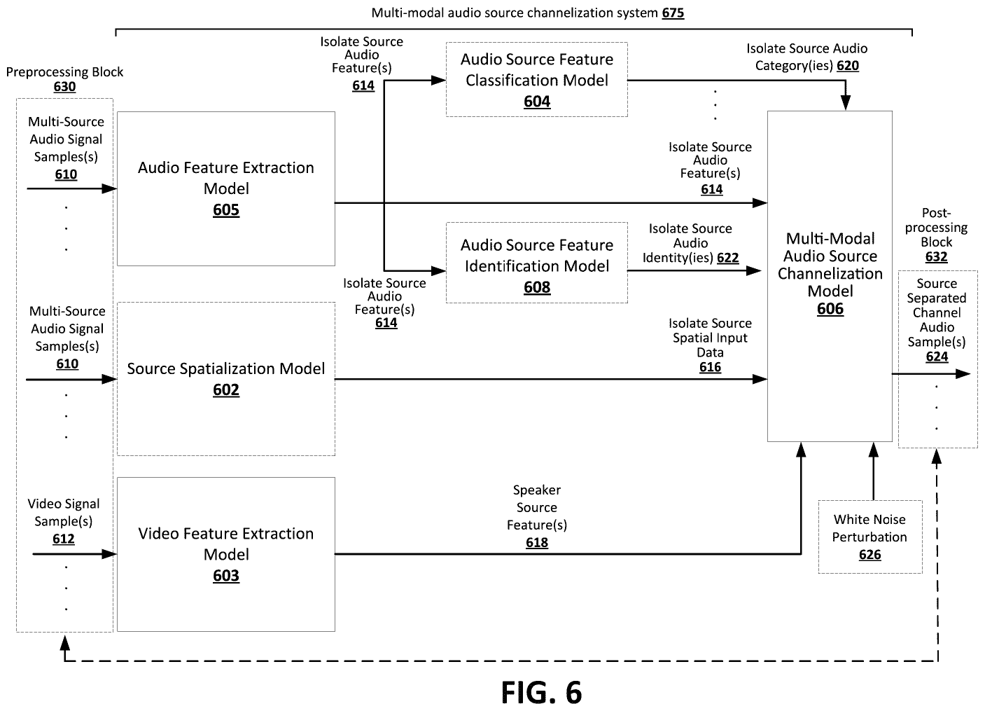

FIG. 6 illustrates example operational flows performed by an example multi-modal audio source channelization system 675 in accordance with one or more example solutions disclosed herein. The depicted multi-modal audio source channelization system 675 includes audio feature extraction model 605, video feature extraction model 603, and multi-modal audio source channelization model 606. The depicted multi-modal audio source channelization system 675 further includes source spatialization model 602, audio source feature classification model 604, and audio source feature identification model 608 that are shown in dashed lines as they may be optionally included or excluded in various example solutions.

The term “source spatialization model” refers to a data construct that describes defined operations of a machine learning model that is configured to generate one or more isolate source spatial input data based on a multi-source audio signal sample. The source spatialization model comprises one or more neural network layers (e.g., one or more fully-connected neural network layers) that are configured to process a multi-source audio signal sample to generate isolate source spatial input data associated with a target audio source identified within the multi-source audio signal sample.

In some examples, the source spatialization model may be applied following the source separation or source identification operations and in parallel with the feature extraction performed by the video feature extraction model discussed above. The source spatialization model is thus configured to generate isolate source spatial input data (e.g., estimated location data, coordinate data, etc.) for each of the one or more isolate source audio features generated by the audio feature extraction model.

Operations of the source spatialization model may be performed by an audio signal processing apparatus. The source spatialization model may be configured to receive one or more multi-source audio signal samples as input to generate one or more isolate source spatial input data. The source spatialization model may be configured to output one or more isolate source spatial input data to a multi-modal audio source channelization model to generate a source separated channel audio sample.

The depicted source spatialization model 602 is configured to receive one or more multi-source audio signal samples 610 from one or more audio capture devices (not shown) and generate isolate source spatial input data 616 corresponding to one or more target audio sources (e.g., target audio sources 101a-d of FIG. 1). The isolate source spatial input data 616 is output to multi-modal audio source channelization model 606 to generate one or more source separated channel audio samples 624. Although not depicted as such, in some examples, the source spatialization model 602 may form a subset of convolutional layers of the above-described audio feature extraction model 605.

The term “isolate source spatial input data” refers to one or more data features extracted by a source spatialization model. Isolate source spatial input data can be a set of features (e.g., parameters, coefficients, matrices, vectors, transformations, representations, or the like) that describe spatialization information associated with a target audio source identified within a multi-source audio signal sample. For instance, isolate source spatial input data may include SNR range data, temperature data, coordinates, 2D polar coordinates, 3D coordinates, audio channel features, audio balance features, audio directionality features, frequency response features, sound source localization features, beamforming features, reverberation information, holography, transfer functions, delay of arrival data, timbre data, filter mask data structures, or the like. Isolate source spatial input data may include data descriptive of a confidence score or ranking associated with the spatialization information associated with a target audio source.

The depicted one or more source separated channel audio samples 624 can include isolate source spatial output data. The term “isolate source spatial output data” refers to one or more features extracted by a multi-modal audio source channelization model. Isolate source spatial output data can be a set of features or metadata (e.g., parameters, coefficients, matrices, vectors, transformations, representations, or the like) that describe spatial information corresponding to a target audio source associated with a source separated channel audio sample. Isolate source spatial output data can be included with a source separated channel audio sample (e.g., appended as metadata).

Isolate source spatial output data may include coordinates, 2D polar coordinates, 3D coordinates, audio channel features, audio balance features, audio directionality features, frequency response features, sound source localization features, beam patterns, room impulse response, head-related transfer functions, delay of arrival data, timbre data, filter mask data structures, or the like. Isolate source spatial input data may include data descriptive of a confidence score or ranking associated with the data descriptive of the spatialization information associated with a target audio source. In some embodiments, isolate source spatial output data is used as input for one or more downstream systems (e.g., one or more audio output devices) that are configured to output spatialized audio (e.g., a virtual reality system, an augmented reality system, a surround-sound enhanced audio/video system, or other audio services that are configured to output spatially localized audio).

In some embodiments, isolate source spatial output data enables tracking a target audio source (e.g., a target speaker) moving about an environment. For example, isolate source spatial output data may provide the location or estimated location of one or more individuals or items of interest (e.g., coordinate data per unit of time associated with a target audio source) that is configured for output to various downstream systems. One example downstream system is a video camera system that is configured to use such data to programmatically define a moving field of view for one or more cameras to capture video of the one or more individuals or items of interest.

In another example, isolate source spatial output data may be used to steer microphone beams, to perform tuning (e.g., digital signal processing) of one or more microphones, to provide spatial information to an application programming interface (API) or other third-party system, or the like. Additionally or alternatively, isolate source spatial output data may be used to dynamically configure and/or alter source separated channel audio samples. For example, orientation, relative location, and/or one or more other characteristics of the source separated channel audio sample may be altered based on the spatial information provided by isolate source spatial output data.

Audio feature extraction model 605 of FIG. 6 is configured to receive one or more multi-source audio signal samples 610 from one or more audio capture devices (not shown) and generate one or more isolate source audio features 614. The one or more isolate source audio features 614 are output to the multi-modal audio source channelization model 606 to generate one or more source separated channel audio samples 624.

The depicted audio source feature classification model 604 is configured to receive one or more isolate source audio features 614 and generate one or more isolate source audio categories 620. For example, audio feature extraction model 605 is configured to input one or more isolate source audio features 614 to audio source feature classification model 604, which is configured to generate one or more isolate source audio categories 620 including a source category corresponding to one or more target audio sources (e.g., target audio sources 101a-d of FIG. 1). The one or more isolate source audio categories 620 are output to multi-modal audio source channelization model 606 to generate one or more source separated channel audio samples 624.

The term “audio source feature classification model” refers to a data construct that describes defined operations of a machine learning model that is configured to generate one or more isolate source audio categories based on isolate source audio features. In some embodiments, operations of the audio source feature classification model may be performed by an audio signal processing apparatus. The audio signal processing apparatus may be configured to provide one or more of the isolate source audio features to the audio source feature classification model to classify the isolate source audio feature into one or more isolate source audio categories.

The depicted audio source feature classification model 604 is comprised of one or more neural network layers (for example, one or more fully-connected neural network layers) that are configured to process one or more isolate source audio features to generate an isolate source audio category for the isolate source audio features. The set of neural network layers are configured to generate, for each potential isolate source audio category of a set of potential isolate source audio categories, a classification score that describes a likelihood that the isolate source audio features belong to the potential isolate source audio category, with the isolate source audio category for the input isolate source audio features being selected as the potential isolate source audio category having a highest classification score or a score that otherwise satisfies a category identification threshold.

Although not depicted as such, the audio source feature classification model 604 may form a subset of convolutional layers of the above described audio feature extraction model 605. The depicted audio source feature classification model 604 is a distinct model positioned as an intermediary between the audio feature extraction model 605 and the multi-modal audio source channelization model 606.

The audio source feature classification model 604 may be configured to determine an isolate source audio category based on isolate source audio features. The audio source feature classification model 604 may be further configured to determine that isolate source audio features are associated with a target audio source based on the determined isolate source audio category being designated as a target audio source category.

The audio source feature classification model 604 may further be configured to determine a number of target audio sources identified. For example, the isolate source audio categories 620 may include data descriptive of the number of unique isolate source audio categories belonging to each category. In this manner, the audio source feature classification model 604 may provide tracking for the number of target audio sources in a multi-source audio signal sample during a particular time window (e.g., counting the number of unique human speakers during a particular time window) and outputting such number as a target audio sources identified indication.

Examples of feature classifications (e.g., isolate source audio categories) associated with an audio source feature classification model may include: voice audio versus noise, stationary noise versus non-stationary noise, male speaker versus female speaker, a voice associated with a known audio source versus a new audio source, near-end audio source versus far-end source (for example, to limit echo propagation), and the like.

The audio source feature classification model 604 may comprise a convolutional autoencoder network, a U-net, a full recurrent network comprised of LSTMs, GRUs, or the like. The audio source feature classification model 604 may be trained using isolate source audio features as input, where inferred output is the desired classifications, and where ground truth data is the actual classifications. In various examples, the model is trained to minimize error between the ground truth data and the inferred output.

The depicted audio source feature identification model 608 is configured to receive one or more isolate source audio features 614 and generate one or more isolate source audio identities 622. For example, audio feature extraction model 605 is configured to input one or more isolate source audio features 614 to audio source feature identification model 608, which is configured to generate one or more isolate source audio identities 622 including a source identity corresponding to one or more target audio sources (e.g., target audio sources 101a-d of FIG. 1). The one or more isolate source audio identities 622 are output to multi-modal audio source channelization model 606 to generate one or more source separated channel audio samples 624.

The term “audio source feature identification model” refers to a data construct that describes defined operations of a machine learning model that is configured to generate one or more isolate source audio identities based on isolate source audio features. In some examples, operations of the source spatialization model may be performed by an audio signal processing apparatus. The audio signal processing apparatus may be configured to provide one or more of the isolate source audio features to the audio source feature identification model to label the isolate source audio feature with a unique isolate source audio identity.

The isolate source audio identities may be determined based on mapping and storing speaker voices. For example, a voiceprint repository may be configured to store one or more biometric voice prints and/or voice profiles for various known users. The audio source feature identification model may be configured to compare isolate source audio features to identify individual speakers using the stored voiceprint repository.

The depicted audio source feature identification model 608 is comprised of one or more neural network layers (for example, one or more fully-connected neural network layers) that are configured to process one or more isolate source audio features to generate an isolate source audio identity for the isolate source audio features. The set of neural network layers are configured to generate, for each potential isolate source audio identity of a set of potential isolate source audio identities, a score that describes a likelihood that the isolate source audio features belong to the potential isolate source audio identity, with the isolate source audio identity for the input isolate source audio features being selected as the potential isolate source audio identity having a highest score or a score that otherwise satisfies an identity identification threshold.

Although not depicted as such, the audio source feature identification model 608 may form a subset of convolutional layers of the above described audio feature extraction model 605. The depicted audio source feature identification model 608 is a distinct model positioned as an intermediary between the audio feature extraction model 605 and the multi-modal audio source channelization model 606.

Video feature extraction model 603 of FIG. 6 is configured to receive one or more video signal samples 612 from one or more video capture devices (not shown) and generate one or more speaker source features 618. The one or more speaker source features 618 are output to the multi-modal audio source channelization model 606 to generate one or more source separated channel audio samples 624.

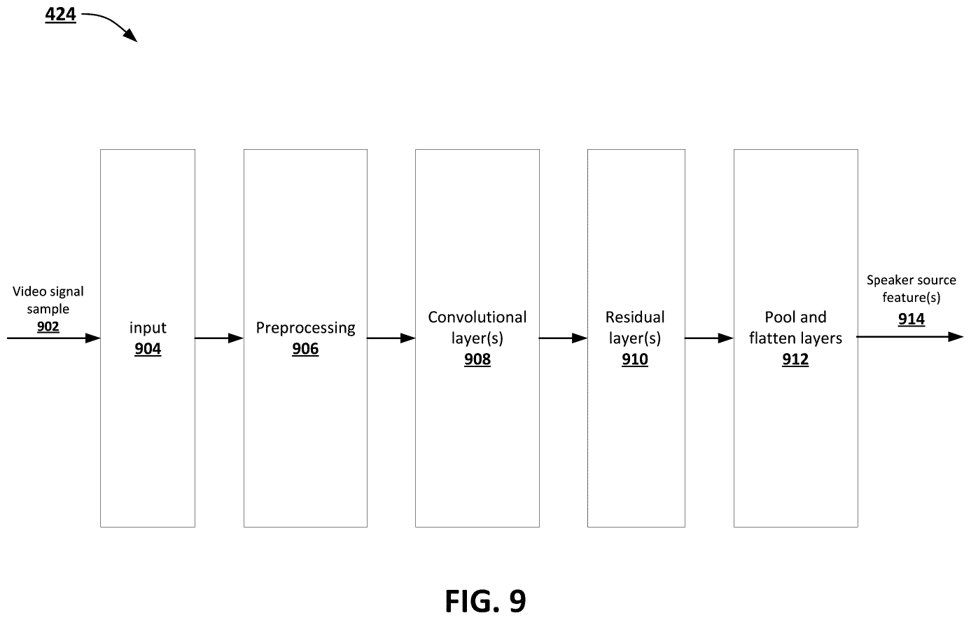

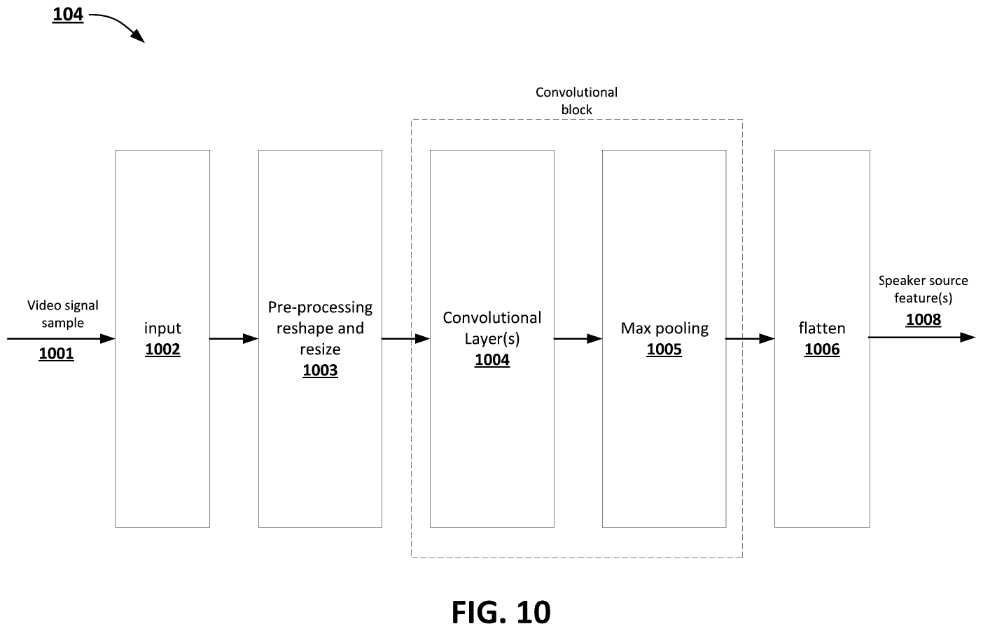

The depicted video feature extraction model 603 is comprised of a convolutional autoencoder network, a U-net, a full recurrent network comprised of LSTMs, GRUs, or the like. In some embodiments, although not shown, the video feature extraction model may include convolutional layers (or sub models) that are directed to speaker source classification and speaker source identification functionality. The depicted video feature extraction model 603 may further be configured to deploy the speaking indication sub model of FIG. 9 and the face identification sub model of FIG. 10, which are discussed in detail below.

Multi-modal audio source channelization model 606 of FIG. 6 is configured to receive one or more isolate source audio features 614 and one or more speaker source features 618, and optionally further receive one or more isolate source audio categories 620, one or more isolate source audio identities 622, and/or isolate source spatial input data 616 to generate one or more source separated channel audio samples 624 associated with one or more respective target audio sources.

The depicted multi-modal audio source channelization model 606 is configured to directly generate one or more source separated channel audio samples 624. The depicted multi-modal audio source channelization model 606 comprises one or more feature engineering layers that are configured to apply feature processing operations to one or more inputs to generate a set of audio features, and one or more generative neural network layers that are configured to process the set of audio features (optionally along with a white noise perturbation input 626) to generate the source separated channel audio sample(s) 624.

Preprocessing service 630 and post-processing service 632 are shown in dotted lines as they may be optionally included or excluded in various examples. Preprocessing service 630 represents various preprocessing operations that may be used in association with an audio/video capture device or immediately downstream of the same. The preprocessing operations may include (a) video signal sample preprocessing operations, (b) multi-source audio signal sample preprocessing operations, (c) audio capture device control operations, and (d) video capture device control operations. More particularly, the preprocessing operations may include speaker source detection, region of interest detection and/or classification, target audio source tracking, steering microphone beams, beamforming, digital signal processing, time/frequency transformation, filtering, scaling, windowing, steering camera views, panning, tilting, target audio source tracking, image cropping, and the like.

Post-processing service 632 represents various post-processing operations that may be applied to a source separated channel audio sample 624 or used as feedback to improve incoming audio and video feeds. Post-processing operations may include (a) source separated channel audio sample post-processing operations, (b) video signal sample preprocessing service feedback operations, and (c) multi-source audio signal sample preprocessing service feedback operations. For example, post-processing operations may include extracting information related to steering microphone beams, extracting information related to steering cameras, extracting information to improve digital signal processing, filtering, denoising, echo cancelation, and feedback loop operations directed to each of the same that are configured to improve video inputs, audio inputs, and the source separated channel audio sample outputs.

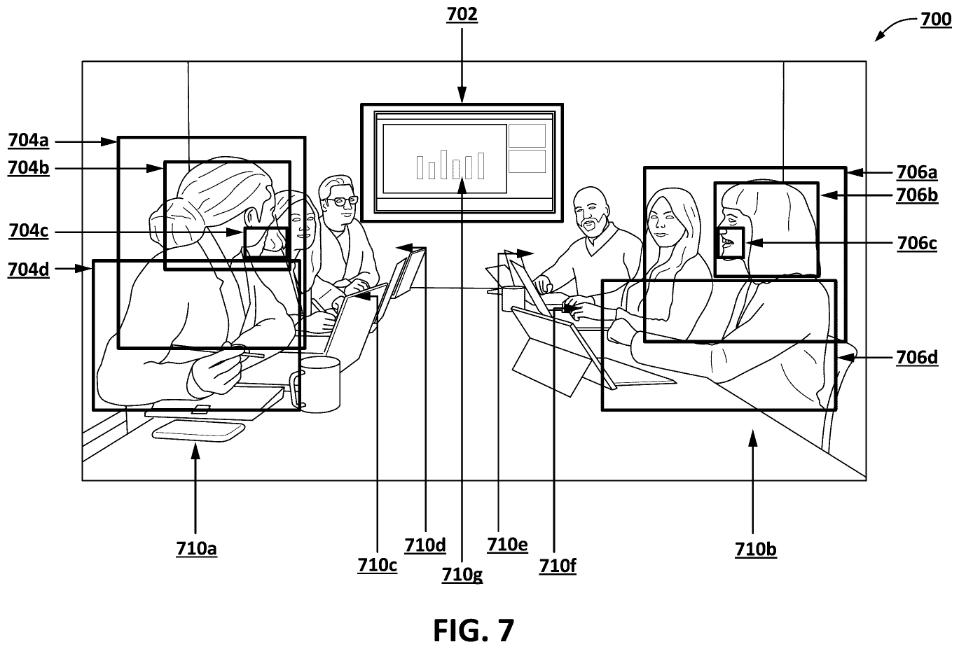

FIG. 7 illustrates an example video frame 700 of a video signal sample structured in accordance with one or more embodiments disclosed herein. The video frame 700 includes target audio sources 710a-g. Target audio sources 710a-e are humans in a conference meeting environment and target audio source 710g is a sound producing television on the wall. Some target audio sources can simultaneously produce sound while other target audio sources may not be producing sound at a particular time interval. For example, at a time captured by the depicted video frame 700, target audio sources 710a-b are simultaneously speaking, target audio source 710g is intermittently producing sound, and target audio sources 710c-f are not speaking.

Video feature extraction models (e.g., video feature extraction model 104 of FIG. 1, video feature extraction model 416 of FIG. 4, video feature extraction model 508 of FIG. 5, video feature extraction model 603 of FIG. 6, etc.) structured as discussed herein are configured to use bounding boxes to improve feature extraction and model training. The term “bounding box” refers to a virtual box or rectangle that is generated by a computer vision system for object identification, object detection, and image processing. Such bounding boxes are used to supplement or guide various video extraction models discussed herein in the identification of one or more speaking indications and/or extraction of one or more speaker source features associated with a target audio source (e.g., target audio source 710a-g). For example, bounding boxes may be used to inform or guide the speaking indication sub model or face identification sub model discussed respectively below in connection with FIGS. 8 and 9.

In still other examples, bounding boxes may be used by the speaker source detectors described in FIGS. 4 and 5 in determining if video signal samples include target audio source image information sufficient to produce speaker source features. Said differently, bounding boxes may be used by speaker source detectors to determine if a video processing path or a multi-modal channelization route should be engaged or dis-engaged.

Video frame 700 depicts example bounding boxes for target audio sources 710a-b and target audio source 710g. For simplicity, bounding boxes are not depicted for target audio sources 710c-f; however, similar operations may be performed for target audio sources 710c-f. For target audio sources 710a-b, bounding boxes are generated to help define facial speaking indications (e.g., 704b, 706b), lip movement speaking indications (e.g., 704c, 706c), and body pose speaking indications (e.g., 704d, 706d). Bounding boxes may also be used to define a search area in which a face for a target audio source (e.g., person of interest) may be located within for one or more future video frames during a next time interval of the video signal sample (e.g., 704a, 706a).

By extracting speaker source features representative of speaking indications associated with a target audio source, channelization may be improved in difficult audio environments (e.g., environments having simultaneous speakers, simultaneous speakers and simultaneous noise producers, etc.). For example, in the conference room environment depicted in the video frame of FIG. 7, the multi-source audio signal sample captured by an audio capture device in the environment (not shown) includes mixed audio of target audio sources 710a-b and target audio source 710g.

To accurately channelize audio for target audio source 710a separately from audio from target audio source 710b, multi-modal audio source channelization models configured as discussed herein may correlate speaker source features corresponding to isolate source audio features. For example, lip movements, body poses, hand gestures, and the like may indicate subtle temporal differences in moments when target audio source 710a is speaking versus when target audio source 710b is speaking. Lip movements associated with speaker source features may correlate to particular isolate source audio features such as the particular phonetics associated with a spoken word at a given moment. Further, relative positional information associated with speaker source features may correlate to positional information associated with isolate source audio features and/or isolate source spatial input data.

Speaker source features may be determined and confirmed in relation to similar features associated with a non-speaker, such as target audio source(s) 710c-f. Speaker source features associated with target audio source(s) 710c-f may indicate no lip movement and/or a non-speaking posture. The multi-modal audio source channelization model may be trained to learn to use such features to avoid erroneously correlating audio from speaking target audio source(s) 710a-b with non-speaking target audio source(s) 710c-f.

The video feature extraction model can be configured to process target audio sources corresponding to an audio source image category of a target audio source. In some embodiments, such audio source image categories may be determined by an audio source image classification model (not shown) that may form part of the convolutional layers of the video feature extraction model or may be embodied as a distinct model positioned downstream of or in parallel to the video feature extraction model. Audio source image categories may include human speakers, human non-speakers, televisions, wall speakers, desk speakers, HVAC systems, pets, and the like.

In some embodiments, bounding box configurations may depend on the audio source image category that is determined for a particular target audio source. For example, target audio source 710g is determined to define a different bounding box configuration 702 than those used for target audio sources 710a-f because target audio source 710g is categorized as a television or monitor while target audio sources 710a-f are categorized as humans.

In some embodiments, the isolate source audio features and/or isolate source spatial input data may be used to inform the video feature extraction model of a location of a target audio source for feature extraction and/or bounding box configurations. For example, position information associated with a target audio source (e.g., direction of arrival data extracted from an audio signal sample) may be used to locate the target audio source in a video signal sample.

FIG. 8 depicts an example architecture for use as an example speaking indication sub model 422 (as shown in FIG. 4) in accordance with one or more embodiments disclosed herein. Speaking indication sub model 422 is configured to receive video signal sample 802 at input 804 which feeds into video into preprocessing service 806. Preprocessing service 806 may include one or more preprocessing operations such as region of interest detection, lip detection, cropping, reshaping, resizing, buffering, and similar operations. For example, preprocessing service 806 may include preprocessing operations performed on video frames of video signal sample 802 to generate associated image data such as on one or more virtual bounding boxes or regions of interest that are predicted to include lip movement indications or the like associated with a target audio source. Preprocessing service 806 feeds into vision neural network 808.

Vision neural network 808 may comprise one or more neural network layers (e.g., one or more fully-connected neural network layers) that are configured to process the output of preprocessing service 806 and feed into to the temporal convolutional network 810. In some embodiments, vision neural network 808 may be configured based on ShuffleNet V2 or the like. The depicted vision neural network 808 may be a lightweight convolutional neural network optimized for speed of processing to produce low latency outputs that are needed for audio systems.

Temporal convolutional network 810 may comprise one or more neural network layers (e.g., one or more fully-connected neural network layers, one or more dilated, causal 1D convolutional layers) that are configured to process the output of vision neural network 808 and generate the one or more speaker source features 812. The temporal convolutional network 810 is configured to be adaptive for sequential data.

FIG. 9 depicts an example architecture for use within an example face identification sub model 424 in accordance with one or more embodiments disclosed herein. Face identification sub model 424 is configured to receive video signal sample 902 at input 904 which feeds into preprocessing service 906. Preprocessing service 906 may include one or more preprocessing operations such as region of interest detection, face detection, cropping, reshaping, resizing, buffering, and similar operations. For example, preprocessing service 906 may include preprocessing operations performed on video frames of video signal sample 902 to generate associated image data such as on one or more virtual bounding boxes or regions of interest that are predicted to include facial information or the like associated with a target audio source. Preprocessing service 906 feeds into convolutional layers 908.

Convolutional layers 908 may comprise one or more neural network layers (e.g., one or more fully-connected neural network layers) and activation functions that are configured to process the output of preprocessing service 906 and that feed into residual layers 910. Although not depicted as such, convolutional layers 908 may form a subset of a ResNet model or the like. Similarly, residual layers 910 may comprise one or more neural network layers and activation functions that are configured to process the output of convolutional layers 908 and feed into pool and flatten layers 912. Although not depicted as such, residual layers 910 may form a subset of a ResNet model or the like. Pool and flatten layers 912 may comprise a pooling layer (e.g., max pooling, global average pooling, etc.) and a flatten layer configured to receive and process the output from residual layers 910 to output the one or more speaker source features 914.

FIG. 10 depicts an example architecture for use within an example video feature extraction model 104 (as shown in FIG. 1) in accordance with one or more examples solutions disclosed herein. Video feature extraction model 104 comprises an input 1002 that receives video signal sample 1001 from one or more video capture devices (e.g., video capture device 102a-n of FIG. 1). The input 1002 feeds the video signal sample 1001 to pre-processing, re-shape, and resize layer 1003 that is configured to prepare the input data for further processing and may include operations such as normalization, data augmentation, and resizing.

The depicted video feature extraction model 104 further comprises one or more convolutional blocks comprising convolutional layer(s) 1004 and max pooling layer(s) 1005. The one or more convolutional blocks may are configured to extract one or more features (e.g., speaker source features, etc.) related to the video signal sample.

The video feature extraction model 104 further comprises a flatten layer 1006 that is configured to transform an extracted features into a one-dimensional output (e.g., speaker source features 1008). The output can represent one or more speaker source features 1008 in a form usable by a multi-modal audio source channelization model (e.g., multi-modal audio source channelization model 108a-b) to generate one or more source separated channel audio samples (e.g., source separated channel audio samples 109a-b of FIG. 1) or one or more source separated channel audio masks (e.g., source separated channel audio mask 414 of FIG. 4).

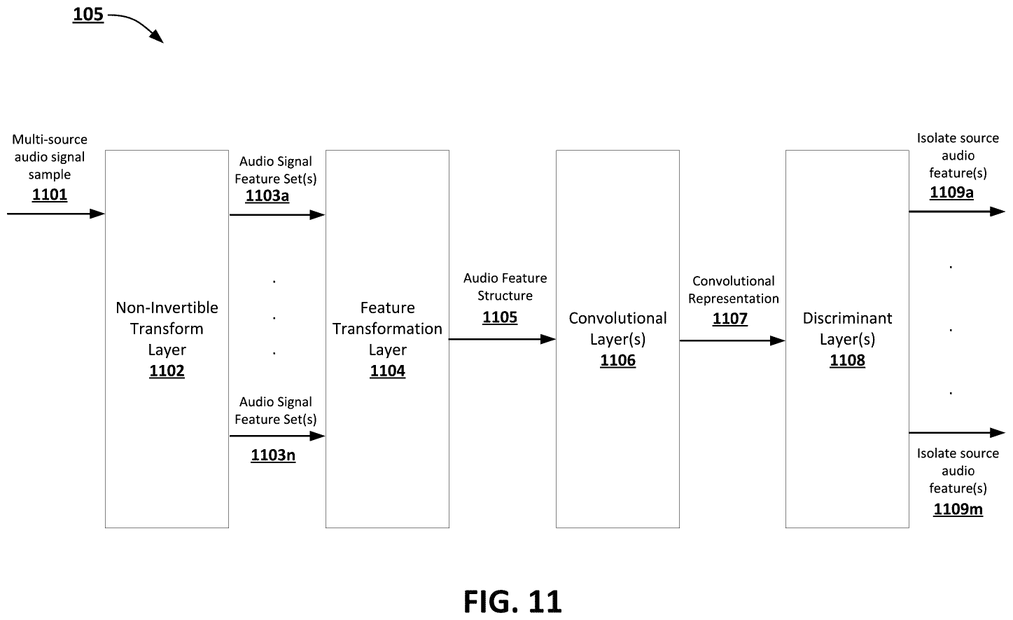

FIG. 11 depicts an example architecture for use within an example audio feature extraction model 105 (as shown in FIG. 1) in accordance with one or more examples disclosed herein. Audio feature extraction model 105 includes a non-invertible transform layer 1102 that is configured to perform one or more feature extractions or non-invertible transformation operations on a multi-source audio signal sample 1101 to generate one or more audio signal feature sets 1103a-n such that the audio signal feature sets 1103a-n are converted into non-invertible form. The non-invertible audio signal feature sets 1103a-n are configured to provide detailed information about the multi-source audio signal sample 1101 that may aid in channelization operations.

Each audio signal feature set 1103a-n can be a one-dimensional data structure that describes a set of amplitude waves, where each amplitude wave is associated with a time designation. Each audio signal feature set 1103a-n may also be a two-dimensional data structure that is determined based on at least one of a real spectrogram of a corresponding multi-source audio signal sample, a complex spectrogram of a corresponding multi-source audio signal sample (e.g., multi-source audio signal sample 1101), a Mel-frequency cepstrum representation of the corresponding multi-source audio signal sample, a cochlear gram of the corresponding multi-source audio signal sample, or the like.

The depicted audio feature extraction model 105 further comprises a feature transformation layer 1104 that is configured to combine, transform, or extract one or more of the audio signal feature sets 1103a-n to generate an audio feature structure 1105. The combination, transformation, or extraction of one or more of the audio signal feature sets 1103a-n may result in a representation of extractions or combinations of the audio signal feature sets in a resulting audio feature structure 1105.

In examples where the audio signal feature sets 1103a-n are a one-dimensional structures, the audio signal feature sets 1103a-n are combined or transformed to create a two-dimensional audio feature structure 1105, with the added dimension associated with sensor/signal variations. In examples where each of the audio signal feature sets 1103a-n is a two-dimensional structure, the audio signal feature sets 1103a-n are combined or transformed to create a three-dimensional audio feature structure 1105, with the added dimension associated with sensor/signal variations.

The audio feature extraction model 105 further comprises a set of convolutional layers 1106 that are configured to process the combined, extracted, or transformed audio feature structure 1105 to generate a convolutional representation 1107 of the audio feature structure 1105. When the audio feature structure 1105 is a two-dimensional structure, the set of convolutional layers 1106 perform operations corresponding to a two-dimensional convolutional operation. When the audio feature structure 1105 is a three-dimensional structure, the set of convolutional layers 1106 perform operations corresponding to a three-dimensional convolutional operation. In some embodiments, the convolutional operations performed by the set of convolutional layers 1106 employ kernels that map portions of the audio feature structure 1105 to values spanning a range of time, a range of frequencies and time, or a range of non-invertible transform domains and time. In some examples, the kernels may map to a range of spaces or sensor devices.

The convolutional operations are applied to a degree that covers the maximum time difference between received signals across the largest spatial extent of the audio capture devices (e.g., the time it takes a signal to propagate between the furthest sensors, in number of samples in time). In some examples, the set of convolutional layers 1106 perform convolutional operations of a convolutional U-Net model structure. In still other examples, the set of convolutional layers 1106 perform convolutional operations of a fully-convolutional time-domain audio separation network (Conv-TasNet).

The depicted audio feature extraction model 105 further comprises a set of discriminant layers 1108 that are configured to process the convolutional representation 1107 to generate the isolate source audio features 1109a-m. In some examples, the set of discriminant layers 1108 perform operations of a set of fully-connected neural network layers. In some examples, the set of discriminant layers 1108 perform operations of a machine learning model employing a vector symbolic architecture.

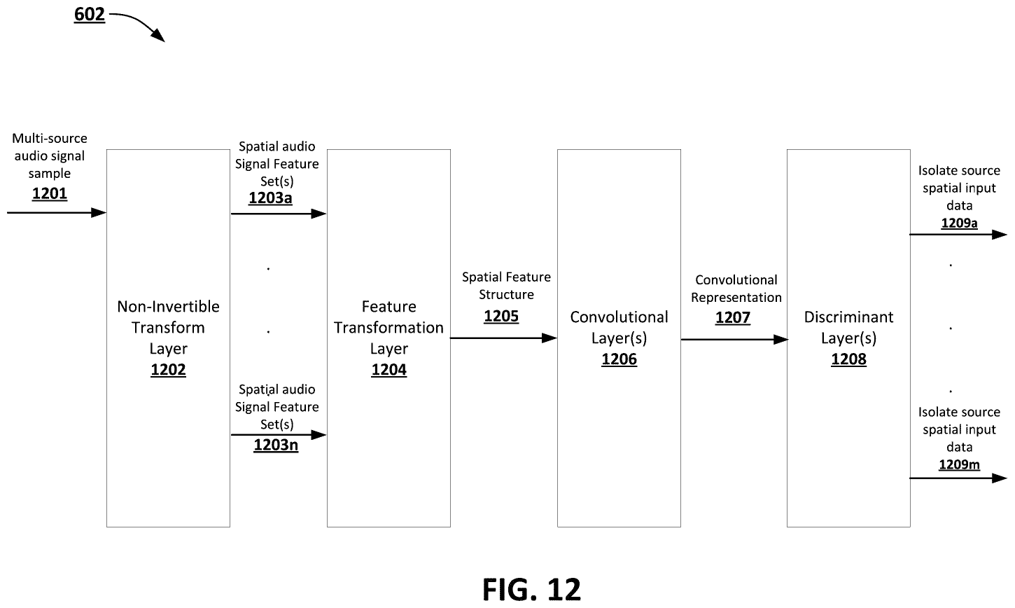

FIG. 12 depicts an example architecture for an example source spatialization model 602 (as shown in FIG. 6) in accordance with one or more embodiments disclosed herein. Source spatialization model 602 comprises a non-invertible transform layer 1202 that is configured to perform one or more feature extractions or non-invertible transformation operations on the multi-source audio signal sample 1201 to generate one or more spatial audio signal feature sets 1203a-n such that the spatial audio signal feature sets 1203a-n are converted to non-invertible form. The non-invertible spatial audio signal feature sets 1203a-n can provide detailed information about the multi-source audio signal sample 1201 that may aid in channelization operations.

The depicted source spatialization model 602 further comprises a feature transformation layer 1204 that is configured to combine, transform, or extract one or more of the spatial audio signal feature sets 1203a-n to generate a spatial feature structure 1205. The combination, transformation, or extraction of one or more of the spatial audio signal feature sets 1203a-n may result in a representation of extractions or combinations of the audio signal feature sets in a resulting spatial feature structure 1205.

In examples where the spatial audio signal feature sets 1203a-n are one-dimensional structures, the spatial audio signal feature sets 1203a-n are combined or transformed to create a two-dimensional spatial feature structure 1205, with the added dimension associated with sensor/signal variations. In examples where the spatial audio signal feature sets 1203a-n are two-dimensional structures, the spatial audio signal feature sets 1203a-n are combined or transformed to create a three-dimensional spatial feature structure 1205, with the added dimension associated with sensor/signal variations.

The depicted source spatialization model 602 further comprises a set of convolutional layers 1206 that are configured to process the combined, extracted, or transformed spatial feature structure 1205 to generate a convolutional representation 1207 of the spatial feature structure 1205. When the spatial feature structure 1205 is a two-dimensional structure, the set of convolutional layers 1206 perform operations corresponding to a two-dimensional convolutional operation. When the spatial feature structure 1205 is a three-dimensional structure, the set of convolutional layers 1206 perform operations corresponding to a three-dimensional convolutional operation. In some examples, the convolutional operations performed by the set of convolutional layers 1206 employ kernels that map portions of the spatial feature structure 1205 to values spanning a range of time, a range of frequencies and time, or a range of non-invertible transform domains and time. In some examples, the kernels may map to a range of spaces or sensor devices.

The convolutional operations are applied to a degree that covers the maximum time difference between received signals across the largest spatial extent of the audio capture devices (e.g., the time it takes a signal to propagate between the most distant sensors in an audio environment). In some examples, the set of convolutional layers 1206 perform convolutional operations of a convolutional U-Net model structure. In some examples, the set of convolutional layers 1206 perform convolutional operations of a fully-convolutional time-domain audio separation network (Conv-TasNet).

The depicted source spatialization model 602 further comprises a set of discriminant layers 1208 that are configured to process the convolutional representation 1207 to generate the isolate source spatial input data 1209a-m. In some examples, the set of discriminant layers 1208 perform operations of a set of fully-connected neural network layers. In still other examples, the set of discriminant layers 1208 perform operations of a machine learning model employing a vector symbolic architecture.

### Model Training

FIG. 13 depicts an example operational flow for training a multi-modal audio source channelization system 1375 in accordance with one or more examples disclosed herein. Audio/video training dataset 1302 includes a plurality of multi-source audio signal samples and a plurality of video signal samples that are aggregated, stored, and otherwise configured for training. In some embodiments, audio/video training dataset 1302 may include a plurality of labelled data, unlabeled data, or a combination of both such that audio/video training dataset 1302 may be used in a supervised training process, an unsupervised training process, or a semi supervised training process.

In some examples, audio/video training dataset 1302 may include data objects that describe one or more input properties (e.g., speaker source features, isolate source audio features) of a predictive entity (e.g., a multi-modal audio source channelization model) along with one or more ground-truth event labels for input properties that correlate to desired outputs of the predictive entity (e.g., source separated channel audio samples).

Video training data (e.g., collections of video signal samples) associated with target audio sources 1304a-n is provided to the video feature extraction model 1306. In the depicted example, video feature extraction model 1306 includes a speaking indication sub model and a face identification sub model as shown. The depicted video feature extraction model 1306 is configured to output speaker source features 1308 to multi-modal audio source channelization model 1310.

Multi-source audio signal samples 1312a (e.g., audio training data) associated with target audio sources 1304a-n are provided to the audio feature extraction model 1314. Audio feature extraction model 1314 is configured to receive one or more multi-source audio signal samples 1312a and output one or more isolate source audio features 1316 to multi-modal audio source channelization model 1310.

Multi-modal audio source channelization model 1310 is configured to receive the speaker source features 1308 and isolate source audio features 1316 and to generate one or more source separated channel audio samples 1318 based on such inputs.

The source separated channel audio samples 1318 may be compared against corresponding ground truth data from audio/video training dataset 1302 to determine a loss function. Alternatively, the source separated channel audio samples 1318 may be compared against corresponding ground truth data generated by audio feature embedding model 1320. For example, multi-source audio signal sample 1312b may be provided to audio feature embedding model 1320 along skip connection audio source separation path 1330, where audio feature embedding model 1320 is configured to generate an output (e.g., an embedding) representative of the ground truth data used to determine a loss function when compared against corresponding source separated channel audio samples 1318 (e.g., based on the dissimilarity between the two respective embeddings). Such examples are effectively configured to compare loss between two embeddings from the same target audio source (e.g., the same speaking individual) based on the dissimilarity between the two embeddings.

In some other examples, a triplet loss may be determined. For example, the loss function may be determined by comparing an embedding from a target audio source (e.g., a first speaking individual) with one embedding from the same target audio source and one embedding from a different target audio source (e.g., a second speaking individual). Such examples are effectively configured to compare loss between different target audio sources (e.g., different speaking individuals) based on the dissimilarity between the three embeddings.

Multi-modal audio source channelization model 1310, video feature extraction model 1306, and or audio feature extraction model 1314 may be iteratively trained to minimize the determined loss function until a predetermined training threshold is satisfied (i.e., until the source separated channel audio sample output is determined to be sufficiently accurate when compared to known source separated channel audio sample outputs). In some embodiments, the depicted training operations may employ a local optimization method or global optimization method, such as gradient descent and/or gradient descent with backpropagation, or the like, to update parameters of one or more models of the multi-modal audio source channelization system 1375.

### Example Method

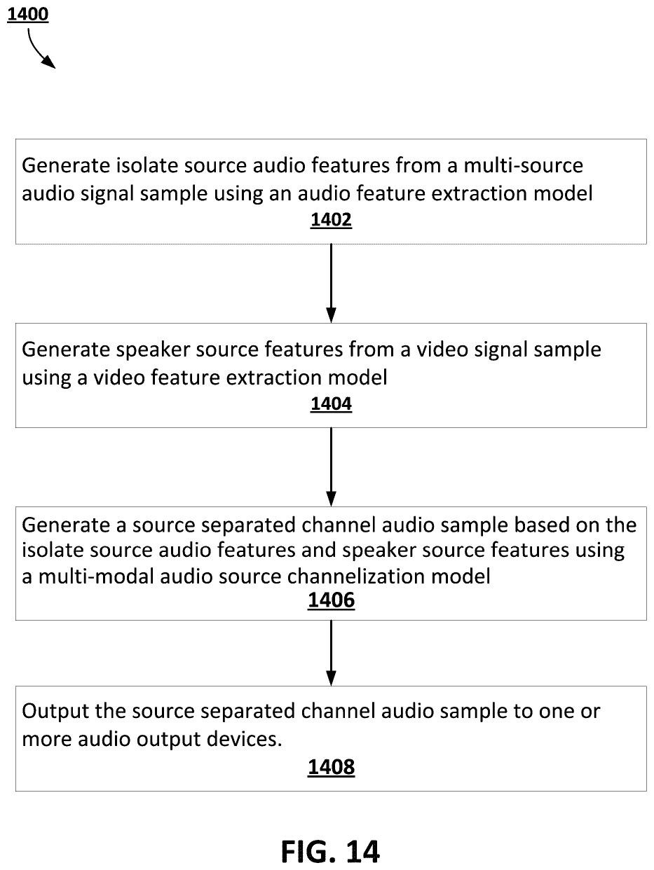

FIG. 14 illustrates an example method 1400 for using multi-modal audio source channelization systems in accordance with one or more embodiments of the present disclosure. At operation 1402, a multi-source audio signal sample associated with at least one audio capture device is input to an audio feature extraction model that is configured to generate one or more isolate source audio features from the multi-source audio signal sample.

At operation 1404, a video signal sample associated with at least one video capture device is input to a video feature extraction model that is configured to generate one or more speaker source features from the video signal sample.

At operation 1406, one or more isolate source audio features and one or more speaker source features are input to a multi-modal audio source channelization model that is configured to generate a source separated channel audio sample based at least in part on the one or more isolate source audio features and on the one or more speaker source features.

At operation 1408, the source separated channel audio sample is output to one or more audio output devices.

### Example Apparatus

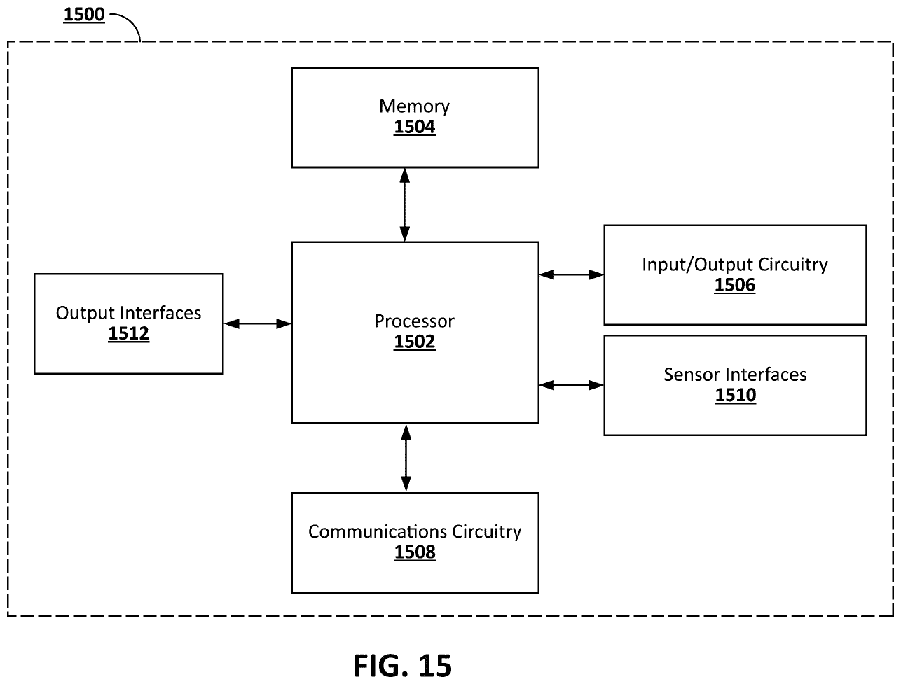

An example audio signal processing apparatus configured in accordance with one or more embodiments of the present disclosure is depicted in the apparatus 1500 of FIG. 15. As depicted in FIG. 15, the apparatus 1500 includes processor 1502, memory 1504, input/output circuitry 1506, and communications circuitry 1508. Although these components 1502-1512 are described with respect to functional limitations, it should be understood that the particular implementations necessarily include the use of particular hardware. It should also be understood that certain of these components 1502-1512 may include similar or common hardware. For example, two sets of circuitries may both leverage use of the same processor, network interface, storage medium, or the like to perform their associated functions, such that duplicate hardware is not required for each set of circuitries.

In one embodiment, the processor 1502 (and/or co-processor or any other processing circuitry assisting or otherwise associated with the processor) may be in communication with the memory 1504 via a bus for passing information among components of the apparatus. The memory 1504 is non-transitory and may include, for example, one or more volatile and/or non-volatile memories. In other words, for example, the memory 1504 may be an electronic storage device (e.g., a computer-readable storage medium). The memory 1504 may be configured to store information, data, content, applications, instructions, or the like for enabling the apparatus to carry out various functions in accordance with example embodiments of the present disclosure. For example, the memory 1504 may be configured to store multi-source audio signal sample data, video signal sample data, isolate source audio feature data, speaker source feature data, isolate source spatial input data, isolate source spatial output data, audio feature extraction model data, video feature extraction model data, source spatialization model data, multi-modal source channelization model data, target audio source generated audio sample data, target audio source machine learning model data, target audio source spatial data, target audio source data, audio sample standard data, and the like.

The processor 1502 may be embodied in a number of different ways and may, for example, include one or more processing devices configured to perform independently. In some preferred and non-limiting embodiments, the processor 1502 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some embodiments, the processor 1502 may be a central processing unit (CPU), a microprocessor, a coprocessor, an Advanced RISC Machine (ARM), a field programmable gate array (FPGA), a controller, or a processing element. The processor 1502 may also be embodied in various other processing circuitry including integrated circuits such as, for example, a microcontroller unit (MCU), an ASIC (application specific integrated circuit), a hardware accelerator (for example, a neural processor unit or NPU), or a special-purpose electronic chip. Furthermore, in some embodiments, the processor 1502 may include one or more processing cores configured to perform independently. A multi-core processor may enable multiprocessing within a single physical package. Additionally or alternatively, the processor may include one or more processors configured in tandem via the bus to enable independent execution of instructions, pipelining, and/or multithreading.

In some preferred and non-limiting embodiments, the processor 1502 may be configured to execute instructions stored in the memory 1504 or otherwise accessible to the processor 1502. In some preferred and non-limiting embodiments, the processor 1502 may be configured to execute hard-coded functionalities. As such, whether configured by hardware or software methods, or by a combination thereof, the processor 1502 may represent an entity (e.g., physically embodied in circuitry) capable of performing operations according to an embodiment of the present disclosure while configured accordingly. Alternatively, as another example, when the processor 1502 is embodied as an executor of software instructions, the instructions may specifically configure the processor 1502 to perform the algorithms and/or operations described herein when the instructions are executed.

In one embodiment, the apparatus 1500 may include input/output circuitry 1506 that may, in turn, be in communication with processor 1502 to provide output to the user and, in one embodiment, to receive an indication of a user input. The input/output circuitry 1506 may comprise a user interface and may include a display, and may comprise a web user interface, a mobile application, a client device, a kiosk, or the like. In one embodiment, the input/output circuitry 1506 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 1504, and/or the like).

The communications circuitry 1508 may be any means such as a device or circuitry embodied in either hardware or a combination of hardware and software that is configured to receive and/or transmit data from/to a network and/or any other device, circuitry, or module in communication with the apparatus 1500. In this regard, the communications circuitry 1508 may include, for example, a network interface for enabling communications with a wired or wireless communication network.

The sensor interfaces 1510 may be configured to receive audio signals from the audio capture devices 103a-m. Examples of audio capture devices 103a-m include microphones (including wireless microphones) and wireless audio receivers. Wireless audio receivers, wireless microphones, and other wireless audio sensors typically include antennas for transmitting and receiving radio frequency (RF) signals which contain digital or analog signals, such as modulated audio signals, data signals, and/or control signals. A wireless audio receiver may be configured to receive RF signals from one or more wireless audio transmitters over one or more channels and corresponding frequencies. For example, a wireless audio receiver may have a single receiver channel so that the receiver is able to wirelessly communicate with one wireless audio transmitter at a corresponding frequency. As another example, a wireless audio receiver may have multiple receiver channels, where each channel can wirelessly communicate with a corresponding wireless audio transmitter at a respective frequency.

The sensor interfaces 1510 may be configured to receive video signals from the video capture devices 102a-n. Examples of video capture devices 102a-n include digital and non-digital cameras.

The output interfaces 1512 may be configured to provide generated audio samples (e.g., source separated channel audio samples 109a-b) to audio output devices.

In some embodiments, the communications circuitry 1508 may include one or more network interface cards, antennae, buses, switches, routers, modems, and supporting hardware and/or software, or any other device suitable for enabling communications via a network. Additionally or alternatively, the communications circuitry 1508 may include the circuitry for interacting with the antenna/antennae to cause transmission of signals via the antenna/antennae or to handle receipt of signals received via the antenna/antennae.

It is also noted that all or some of the information discussed herein can be based on data that is received, generated and/or maintained by one or more components of apparatus 1500. In one embodiment, one or more external systems (such as a remote cloud computing and/or data storage system) may also be leveraged to provide at least some of the functionality discussed herein.

With respect to components of the apparatus 1500, the term “circuitry” as used herein and defined above should therefore be understood to include particular hardware configured to perform the functions associated with the particular circuitry as described herein. For example, in one embodiment, “circuitry” may include processing circuitry, storage media, network interfaces, input/output devices, and the like. In one embodiment, other elements of the apparatus 1500 may provide or supplement the functionality of particular circuitry. For example, the processor 1502 may provide processing functionality, the memory 1504 may provide storage functionality, the communications circuitry 1508 may provide network interface functionality, and the like. Similarly, other elements of the apparatus 1500 may provide or supplement the functionality of particular circuitry.

As will be appreciated, any such computer program instructions and/or other type of code may be loaded onto a computer, processor or other programmable apparatus's circuitry to produce a machine, such that the computer, processor or other programmable circuitry that execute the code on the machine creates the means for implementing various functions, including those described herein.

As described above and as will be appreciated based on this disclosure, embodiments of the present disclosure may be configured as methods, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, CD-ROMs, flash memory, optical storage devices, or magnetic storage devices.

While this specification contains many specific implementation details, these should not be construed as limitations on the scope of any disclosures or of what may be claimed, but rather as description of features specific to particular examples of particular disclosures. Certain features that are described herein in the context of separate examples can also be implemented in combination in a single example. Conversely, various features that are described in the context of a single example can also be implemented in multiple examples separately or in any suitable sub-combination. Although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results, unless described otherwise. In certain circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

Hereinafter, various characteristics will be highlighted in a set of numbered clauses or paragraphs. These characteristics are not to be interpreted as being limiting on the invention or inventive concept, but are provided merely as a highlighting of some characteristics as described herein, without suggesting a particular order of importance or relevancy of such characteristics.

Clause 1. An audio signal processing apparatus comprising one or more processors and one or more memories storing instructions that are operable, when executed by the one or more processors, to cause the audio signal processing apparatus to: input a multi-source audio signal sample associated with at least one audio capture device to an audio feature extraction model that is configured to generate one or more isolate source audio features from the multi-source audio signal sample, input a video signal sample associated with at least one video capture device to a video feature extraction model that is configured to generate one or more speaker source features from the video signal sample; input the one or more isolate source audio features and one or more speaker source features to a multi-modal audio source channelization model that is configured to generate a source separated channel audio sample based at least in part on the one or more isolate source audio features and on the one or more speaker source features; and output the source separated channel audio sample to one or more audio output devices.

Clause 2. An audio signal processing apparatus according to the foregoing Clause, wherein the multi-source audio signal sample is captured by multiple audio capture devices over multiple audio channels.

Clause 3. An audio signal processing apparatus according to any of the foregoing Clauses, wherein the multi-source audio signal sample is captured by one audio capture device over a single audio channel.

Clause 4. An audio signal processing apparatus according to any of the foregoing Clauses, wherein the multi-modal audio source channelization model is configured to further generate a second source separated channel audio sample based at least in part on the one or more isolate source audio features and on the one or more speaker source features, and output the second source separated channel audio sample to one or more audio output devices.

Clause 5. An audio signal processing apparatus according to any of the foregoing Clauses, wherein the source separated channel audio sample is associated with a first target audio source and the second source separated channel audio sample is associated with a second target audio source.

Clause 6. An audio signal processing apparatus according to any of the foregoing Clauses, wherein the one or more speaker source features generated by the video feature extraction model comprise speaking indications associated with human facial images of the video signal sample.

Clause 7. An audio signal processing apparatus according to any of the foregoing Clauses, wherein the one or more speaker source features generated by the video feature extraction model comprise speaking indications associated with human gesture images of the video signal sample.

Clause 8. An audio signal processing apparatus according to any of the foregoing Clauses, wherein the audio signal processing apparatus is further configured to input the multi-source audio signal sample to a source spatialization model to generate isolate source spatial input data associated with the one or more isolate source audio features, and wherein the one or more isolate source audio features, the isolate source spatial input data, and the one or more speaker source features are input to the multi-modal audio source channelization model to generate the source separated channel audio sample.

Clause 9. An audio signal processing apparatus according to any of the foregoing Clauses, wherein the source separated channel audio sample comprises isolate source spatial output data.

Clause 10. An audio signal processing apparatus according to any of the foregoing Clauses, wherein the video signal sample is a multi-feed video signal sample associated with two or more video capture devices.

Clause 11. An audio signal processing apparatus according to any of the foregoing Clauses, further comprising a preprocessing service upstream of the at least one audio capture device and the at least one video capture device, wherein the preprocessing service is configured to perform one or more of the following: (a) video signal sample preprocessing operations, (b) multi-source audio signal sample preprocessing operations, (c) audio capture device control operations, and (d) video capture device control operations.

Clause 12. An audio signal processing apparatus according to any of the foregoing Clauses further comprising a post-processing service configured to perform one or more of the following: (a) source separated channel audio sample post-processing operations, (b) video signal sample preprocessing service feedback operations, and (c) multi-source audio signal sample preprocessing service feedback operations.

Clause 13. An audio signal processing apparatus according to any of the foregoing Clauses, wherein the audio signal processing apparatus is further configured to input the isolate source audio features to an audio source feature classification model to generate isolate source audio categories associated with the one or more isolate source audio features, and wherein the one or more isolate source audio features, the isolate source audio categories, and the one or more speaker source features are input to the multi-modal audio source channelization model to generate the source separated channel audio sample.

Clause 14. An audio signal processing apparatus according to any of the foregoing Clauses, wherein the isolate source audio categories include a target audio sources identified indication within the multi-source audio signal sample for a given time interval.

Clause 15. An audio signal processing apparatus according to any of the foregoing Clauses, wherein the audio signal processing apparatus is further configured to input the isolate source audio features to an audio source feature identification model to generate isolate source audio identities associated with the one or more isolate source audio features, and wherein the one or more isolate source audio features, the isolate source audio identities, and the one or more speaker source features are input to the multi-modal audio source channelization model to generate the source separated channel audio sample.

Clause 16. An audio signal processing apparatus according to any of the foregoing Clauses, wherein the multi-modal audio source channelization model is configured as a generative adversarial network comprising at least a generator and discriminator.

Clause 17. An audio signal processing apparatus according to any of the foregoing Clauses, wherein training one or more of the video feature extraction model, audio feature extraction model, and/or multi-modal audio source channelization model comprises comparing the source separated channel audio sample against corresponding ground truth data to minimize a loss function, wherein the ground truth data is generated by an audio feature embedding model based on a corresponding multi-source audio signal sample.

Clause 18. An audio signal processing apparatus according to any of the foregoing Clauses, wherein the loss function is determined based on one of the following: (a) a dissimilarity between two embeddings based on a first target audio source, or (b) a triplet loss between two embeddings based on a first target audio source and a third embedding based on a second target audio source.

Clause 19. An audio signal processing apparatus comprising one or more processors and one or more memories storing instructions that are operable, when executed by the one or more processors, to cause the audio signal processing apparatus to: input a multi-source audio signal sample associated with at least one audio capture device to an audio feature extraction model that is configured to generate one or more isolate source audio features from the multi-source audio signal sample; input a video signal sample associated with at least one video capture device to a video feature extraction model that is configured to generate one or more speaker source features from the video signal sample; input the one or more isolate source audio features and one or more speaker source features to a multi-modal audio source channelization model that is configured to generate a source separated channel audio mask based at least in part on the one or more isolate source audio features and on the one or more speaker source features; apply the source separated channel audio mask to the multi-source audio signal sample to generate a source separated channel audio sample; and output the source separated channel audio sample to one or more audio output devices.

Clause 20. An audio signal processing apparatus according to the foregoing Clause, wherein the audio signal processing apparatus is further configured to input the video signal sample to a video buffer configured to synchronize the video signal sample with the multi-source audio signal sample before inputting the video signal sample to the video feature extraction model.

Clause 21. An audio signal processing apparatus according to any of the foregoing Clauses, wherein the audio signal processing apparatus is further configured to input the speaker source features to a speaker source feature buffer configured to synchronize the speaker source features with the isolate source audio features.

Clause 22. An audio signal processing apparatus according to any of the foregoing Clauses, wherein the audio signal processing apparatus is further configured to input the multi-source audio signal sample to an audio buffer configured to synchronize the multi-source audio signal sample with the video signal sample before inputting the multi-source audio signal sample to the audio feature extraction model.

Clause 23. An audio signal processing apparatus according to any of the foregoing Clauses, wherein the audio signal processing apparatus is further configured to: synchronize the video signal sample with the source separated channel audio sample; and output the video signal sample and the source separated channel audio sample to the one or more audio output devices, wherein the one or more audio output devices comprises a downstream audio and video streaming service.

Clause 24. An audio signal processing apparatus according to any of the foregoing Clauses, wherein the video feature extraction model further comprises a speaking indication sub model configured to receive the video signal sample and generate one or more speaker source features associated with one or more lip-based speaking indications.

Clause 25. An audio signal processing apparatus according to any of the foregoing Clauses, wherein the video feature extraction model further comprises a face identification sub model configured to receive the video signal sample and generate one or more speaker source features associated with one or more facial speaking indications.

Clause 26. An audio signal processing apparatus according to any of the foregoing Clauses, wherein the audio signal processing apparatus is further configured to: apply a transformation to the multi-source audio signal sample to generate a transformed multi-source audio signal sample; apply the source separated channel audio mask to the transformed multi-source audio signal sample; and apply an inverse transformation to the multi-source audio signal sample.

Clause 27. An audio signal processing apparatus comprising one or more processors and one or more memories storing instructions that are operable, when executed by the one or more processors, to cause the audio signal processing apparatus to: receive one or more isolate source audio features generated from a multi-source audio signal sample associated with at least one audio capture device; analyze a video signal sample associated with at least one video capture device to determine if the video signal sample satisfies a speaker source feature generation threshold; in a circumstance in which the video signal sample satisfies the speaker source feature generation threshold: engage a video processing path comprising a video feature extraction model that is configured to generate one or more speaker source features from the video signal sample; input the one or more isolate source audio features and the one or more speaker source features to a multi-modal audio source channelization model that is configured to generate a source separated channel audio sample based at least in part on the one or more isolate source audio features and on the one or more speaker source features; in a circumstance in which the video signal sample does not satisfy the speaker source feature generation threshold: input the one or more isolate source audio features to an audio only source separation model that is configured to generate an audio-based source separated channel audio sample based on the one or more isolate source audio features; and output the source separated channel audio sample or the audio-based source separated channel to one or more audio output devices.

Clause 28. An audio signal processing apparatus according to the foregoing Clause, wherein the audio signal processing apparatus is further caused to engage a multi-modal channelization route in the circumstance in which the video signal sample satisfies the speaker source feature generation threshold, and wherein the multi-modal channelization route comprises the video processing path and an audio processing path, wherein the audio processing path comprises applying an audio feature extraction model to the multi-source audio signal sample to generate the one or more isolate source audio features.

Clause 29. An audio signal processing apparatus according to any of the foregoing Clauses, wherein the audio signal processing apparatus is further caused to engage an audio channelization route in the circumstance in which the video signal sample does not satisfy the speaker source feature generation threshold, and wherein the audio channelization route comprises applying an audio feature extraction model to the multi-source audio signal sample to generate the one or more isolate source audio features.

Clause 30. An audio signal processing apparatus according to any of the foregoing Clauses, further comprising a speaker source detector configured to analyze the video signal sample associated with at least one video capture device to determine if the video signal sample satisfies the speaker source feature generation threshold.

Clause 31. An audio signal processing apparatus according to any of the foregoing Clauses, wherein the video signal sample does not satisfy the speaker source feature generation threshold in circumstances in which the audio signal processing apparatus determines that one or more target audio sources associated with the video signal sample are obscured or hidden.

Clause 32. A computer program product comprising at least one non-transitory computer readable storage medium having computer-readable program code portions stored thereon that, when executed by at least one processor, cause an apparatus to: input a multi-source audio signal sample associated with at least one audio capture device to an audio feature extraction model that is configured to generate one or more isolate source audio features from the multi-source audio signal sample; input a video signal sample associated with at least one video capture device to a video feature extraction model that is configured to generate one or more speaker source features from the video signal sample; input the one or more isolate source audio features and one or more speaker source features to a multi-modal audio source channelization model that is configured to generate a source separated channel audio sample based at least in part on the one or more isolate source audio features and on the one or more speaker source features; and output the source separated channel audio sample to one or more audio output devices.

Clause 33. A computer program product according to the foregoing Clause, wherein the multi-source audio signal sample is captured by multiple audio capture devices over multiple audio channels.

Clause 34. A computer program product according to any of the foregoing Clauses, wherein the multi-source audio signal sample is captured by one audio capture device over a single audio channel.

Clause 35. A computer program product according to any of the foregoing Clauses32, wherein the multi-modal audio source channelization model is configured to further generate a second source separated channel audio sample based at least in part on the one or more isolate source audio features and on the one or more speaker source features, and output the second source separated channel audio sample to one or more audio output devices.

Clause 36. A computer program product according to any of the foregoing Clauses, wherein the source separated channel audio sample is associated with a first target audio source and the second source separated channel audio sample is associated with a second target audio source.

Clause 37. A computer program product according to any of the foregoing Clauses, wherein the one or more speaker source features generated by the video feature extraction model comprise speaking indications associated with human facial images of the video signal sample.

Clause 38. A computer program product according to any of the foregoing Clauses, wherein the one or more speaker source features generated by the video feature extraction model comprise speaking indications associated with human gesture images of the video signal sample.

Clause 39. A computer program product according to any of the foregoing Clauses, wherein the computer-readable program code portions, when executed by the at least one processor, further cause the apparatus to input the multi-source audio signal sample to a source spatialization model to generate isolate source spatial input data associated with the one or more isolate source audio features, and wherein the one or more isolate source audio features, the isolate source spatial input data, and the one or more speaker source features are input to the multi-modal audio source channelization model to generate the source separated channel audio sample.

Clause 40. A computer program product according to any of the foregoing Clauses, wherein the source separated channel audio sample comprises isolate source spatial output data.

Clause 41. A computer program product according to any of the foregoing Clauses, wherein the video signal sample is a multi-feed video signal sample associated with two or more video capture devices.

Clause 42. A computer program product according to any of the foregoing Clauses, further comprising a preprocessing service upstream of the at least one audio capture device and the at least one video capture device, wherein the preprocessing service is configured to perform one or more of the following: (a) video signal sample preprocessing operations, (b) multi-source audio signal sample preprocessing operations, (c) audio capture device control operations, and (d) video capture device control operations.

Clause 43. A computer program product according to any of the foregoing Clauses further comprising a post-processing service configured to perform one or more of the following: (a) source separated channel audio sample post-processing operations, (b) video signal sample preprocessing service feedback operations, and (c) multi-source audio signal sample preprocessing service feedback operations.

Clause 44. A computer program product according to any of the foregoing Clauses, wherein the computer-readable program code portions, when executed by the at least one processor, further cause the apparatus to input the isolate source audio features to an audio source feature classification model to generate isolate source audio categories associated with the one or more isolate source audio features, and wherein the one or more isolate source audio features, the isolate source audio categories, and the one or more speaker source features are input to the multi-modal audio source channelization model to generate the source separated channel audio sample.

Clause 45. A computer program product according to any of the foregoing Clauses, wherein the isolate source audio categories include a target audio sources identified indication within the multi-source audio signal sample for a given time interval.

Clause 46. A computer program product according to any of the foregoing Clauses, wherein the computer-readable program code portions, when executed by the at least one processor, further cause the apparatus to input the isolate source audio features to an audio source feature identification model to generate isolate source audio identities associated with the one or more isolate source audio features, and wherein the one or more isolate source audio features, the isolate source audio identities, and the one or more speaker source features are input to the multi-modal audio source channelization model to generate the source separated channel audio sample.

Clause 47. A computer program product according to any of the foregoing Clauses, wherein the multi-modal audio source channelization model is configured as a generative adversarial network comprising at least a generator and discriminator.

Clause 48. A computer program product according to any of the foregoing Clauses, wherein training one or more of the video feature extraction model, audio feature extraction model, and/or multi-modal audio source channelization model comprises comparing the source separated channel audio sample against corresponding ground truth data to minimize a loss function, wherein the ground truth data is generated by an audio feature embedding model based on a corresponding multi-source audio signal sample.

Clause 49. A computer program product according to any of the foregoing Clauses, wherein the loss function is determined based on one of the following: (a) a dissimilarity between two embeddings based on a first target audio source, or (b) a triplet loss between two embeddings based on a first target audio source and a third embedding based on a second target audio source.

Clause 50. A computer program product comprising at least one non-transitory computer readable storage medium having computer-readable program code portions stored thereon that, when executed by at least one processor, cause an apparatus to: input a multi-source audio signal sample associated with at least one audio capture device to an audio feature extraction model that is configured to generate one or more isolate source audio features from the multi-source audio signal sample; input a video signal sample associated with at least one video capture device to a video feature extraction model that is configured to generate one or more speaker source features from the video signal sample; input the one or more isolate source audio features and one or more speaker source features to a multi-modal audio source channelization model that is configured to generate a source separated channel audio mask based at least in part on the one or more isolate source audio features and on the one or more speaker source features; apply the source separated channel audio mask to the multi-source audio signal sample to generate a source separated channel audio sample; and output the source separated channel audio sample to one or more audio output devices.

Clause 51. A computer program product according to the foregoing Clause, wherein the computer-readable program code portions, when executed by the at least one processor, further cause the apparatus to input the video signal sample to a video buffer configured to synchronize the video signal sample with the multi-source audio signal sample before inputting the video signal sample to the video feature extraction model.

Clause 52. A computer program product according to any of the foregoing Clauses, wherein the computer-readable program code portions, when executed by the at least one processor, further cause the apparatus to input the speaker source features to a speaker source feature buffer configured to synchronize the speaker source features with the isolate source audio features.

Clause 53. A computer program product according to any of the foregoing Clauses, wherein the computer-readable program code portions, when executed by the at least one processor, further cause the apparatus to input the multi-source audio signal sample to an audio buffer configured to synchronize the multi-source audio signal sample with the video signal sample before inputting the multi-source audio signal sample to the audio feature extraction model.

Clause 54. A computer program product according to any of the foregoing Clauses, wherein the computer-readable program code portions, when executed by the at least one processor, further cause the apparatus to: synchronize the video signal sample with the source separated channel audio sample; and output the video signal sample and the source separated channel audio sample to the one or more audio output devices, wherein the one or more audio output devices comprises a downstream audio and video streaming service.

Clause 55. A computer program product according to any of the foregoing Clauses, wherein the video feature extraction model further comprises a speaking indication sub model configured to receive the video signal sample and generate one or more speaker source features associated with one or more lip-based speaking indications.

Clause 56. A computer program product according to any of the foregoing Clauses, wherein the video feature extraction model further comprises a face identification sub model configured to receive the video signal sample and generate one or more speaker source features associated with one or more facial speaking indications.

Clause 57. A computer program product according to any of the foregoing Clauses, wherein the computer-readable program code portions, when executed by the at least one processor, further cause the apparatus to: apply a transformation to the multi-source audio signal sample to generate a transformed multi-source audio signal sample; apply the source separated channel audio mask to the transformed multi-source audio signal sample; and apply an inverse transformation to the multi-source audio signal sample.

Clause 58. A computer program product comprising at least one non-transitory computer readable storage medium having computer-readable program code portions stored thereon that, when executed by at least one processor, cause an apparatus to: receive one or more isolate source audio features generated from a multi-source audio signal sample associated with at least one audio capture device; analyze a video signal sample associated with at least one video capture device to determine if the video signal sample satisfies a speaker source feature generation threshold; in a circumstance in which the video signal sample satisfies the speaker source feature generation threshold: engage a video processing path comprising a video feature extraction model that is configured to generate one or more speaker source features from the video signal sample; input the one or more isolate source audio features and the one or more speaker source features to a multi-modal audio source channelization model that is configured to generate a source separated channel audio sample based at least in part on the one or more isolate source audio features and on the one or more speaker source features; in a circumstance in which the video signal sample does not satisfy the speaker source feature generation threshold: input the one or more isolate source audio features to an audio only source separation model that is configured to generate an audio-based source separated channel audio sample based on the one or more isolate source audio features; and output the source separated channel audio sample or the audio-based source separated channel to one or more audio output devices.

Clause 59. A computer program product according to the foregoing Clause, wherein the computer-readable program code portions, when executed by the at least one processor, further cause the apparatus to engage a multi-modal channelization route in the circumstance in which the video signal sample satisfies the speaker source feature generation threshold, and wherein the multi-modal channelization route comprises the video processing path and an audio processing path, wherein the audio processing path comprises applying an audio feature extraction model to the multi-source audio signal sample to generate the one or more isolate source audio features.

Clause 60. A computer program product according to any of the foregoing Clauses, wherein the computer-readable program code portions, when executed by the at least one processor, further cause the apparatus to engage an audio channelization route in the circumstance in which the video signal sample does not satisfy the speaker source feature generation threshold, and wherein the audio channelization route comprises applying an audio feature extraction model to the multi-source audio signal sample to generate the one or more isolate source audio features.

Clause 61. A computer program product according to any of the foregoing Clauses, further comprising a speaker source detector configured to analyze the video signal sample associated with at least one video capture device to determine if the video signal sample satisfies the speaker source feature generation threshold.

Clause 62. A computer program product according to any of the foregoing Clauses, wherein the video signal sample does not satisfy the speaker source feature generation threshold in circumstances in which the audio signal processing apparatus determines that one or more target audio sources associated with the video signal sample are obscured or hidden.

Clause 63. A method comprising: inputting a multi-source audio signal sample associated with at least one audio capture device to an audio feature extraction model that is configured to generate one or more isolate source audio features from the multi-source audio signal sample; inputting a video signal sample associated with at least one video capture device to a video feature extraction model that is configured to generate one or more speaker source features from the video signal sample; inputting the one or more isolate source audio features and one or more speaker source features to a multi-modal audio source channelization model that is configured to generate a source separated channel audio sample based at least in part on the one or more isolate source audio features and on the one or more speaker source features; and outputting the source separated channel audio sample to one or more audio output devices.

Clause 64. A method according to the foregoing Clause, wherein the multi-source audio signal sample is captured by multiple audio capture devices over multiple audio channels.

Clause 65. A method according to any of the foregoing Clauses, wherein the multi-source audio signal sample is captured by one audio capture device over a single audio channel.

Clause 66. A method according to any of the foregoing Clauses, wherein the multi-modal audio source channelization model is configured to further generate a second source separated channel audio sample based at least in part on the one or more isolate source audio features and on the one or more speaker source features, and output the second source separated channel audio sample to one or more audio output devices.

Clause 67. A method according to any of the foregoing Clauses, wherein the source separated channel audio sample is associated with a first target audio source and the second source separated channel audio sample is associated with a second target audio source.

Clause 68. A method according to any of the foregoing Clauses, wherein the one or more speaker source features generated by the video feature extraction model comprise speaking indications associated with human facial images of the video signal sample.

Clause 69. A method according to any of the foregoing Clauses, wherein the one or more speaker source features generated by the video feature extraction model comprise speaking indications associated with human gesture images of the video signal sample.

Clause 70. A method according to any of the foregoing Clauses, further comprising inputting the multi-source audio signal sample to a source spatialization model to generate isolate source spatial input data associated with the one or more isolate source audio features, and wherein the one or more isolate source audio features, the isolate source spatial input data, and the one or more speaker source features are input to the multi-modal audio source channelization model to generate the source separated channel audio sample.

Clause 71. A method according to any of the foregoing Clauses, wherein the source separated channel audio sample comprises isolate source spatial output data.

Clause 72. A method according to any of the foregoing Clauses, wherein the video signal sample is a multi-feed video signal sample associated with two or more video capture devices.

Clause 73. A method according to any of the foregoing Clauses, further comprising a preprocessing service upstream of the at least one audio capture device and the at least one video capture device, wherein the preprocessing service is configured to perform one or more of the following: (a) video signal sample preprocessing operations, (b) multi-source audio signal sample preprocessing operations, (c) audio capture device control operations, and (d) video capture device control operations.

Clause 74. A method according to any of the foregoing Clauses, further comprising a post-processing service configured to perform one or more of the following: (a) source separated channel audio sample post-processing operations, (b) video signal sample preprocessing service feedback operations, and (c) multi-source audio signal sample preprocessing service feedback operations.

Clause 75. A method according to any of the foregoing Clauses, further comprising inputting the isolate source audio features to an audio source feature classification model to generate isolate source audio categories associated with the one or more isolate source audio features, and wherein the one or more isolate source audio features, the isolate source audio categories, and the one or more speaker source features are input to the multi-modal audio source channelization model to generate the source separated channel audio sample.

Clause 76. A method according to any of the foregoing Clauses, wherein the isolate source audio categories include a target audio sources identified indication within the multi-source audio signal sample for a given time interval.

Clause 77. A method according to any of the foregoing Clauses, further comprising inputting the isolate source audio features to an audio source feature identification model to generate isolate source audio identities associated with the one or more isolate source audio features, and wherein the one or more isolate source audio features, the isolate source audio identities, and the one or more speaker source features are input to the multi-modal audio source channelization model to generate the source separated channel audio sample.

Clause 78. A method according to any of the foregoing Clauses, wherein the multi-modal audio source channelization model is configured as a generative adversarial network comprising at least a generator and discriminator.

Clause 79. A method according to any of the foregoing Clauses, wherein training one or more of the video feature extraction model, audio feature extraction model, and/or multi-modal audio source channelization model comprises comparing the source separated channel audio sample against corresponding ground truth data to minimize a loss function, wherein the ground truth data is generated by an audio feature embedding model based on a corresponding multi-source audio signal sample.

Clause 80. A method according to any of the foregoing Clauses, wherein the loss function is determined based on one of the following: (a) a dissimilarity between two embeddings based on a first target audio source, or (b) a triplet loss between two embeddings based on a first target audio source and a third embedding based on a second target audio source.

Clause 81. A method comprising: inputting a multi-source audio signal sample associated with at least one audio capture device to an audio feature extraction model that is configured to generate one or more isolate source audio features from the multi-source audio signal sample; inputting a video signal sample associated with at least one video capture device to a video feature extraction model that is configured to generate one or more speaker source features from the video signal sample; inputting the one or more isolate source audio features and one or more speaker source features to a multi-modal audio source channelization model that is configured to generate a source separated channel audio mask based at least in part on the one or more isolate source audio features and on the one or more speaker source features; applying the source separated channel audio mask to the multi-source audio signal sample to generate a source separated channel audio sample; and outputting the source separated channel audio sample to one or more audio output devices.

Clause 82. A method according to the foregoing Clause, further comprising inputting the video signal sample to a video buffer configured to synchronize the video signal sample with the multi-source audio signal sample before inputting the video signal sample to the video feature extraction model.

Clause 83. A method according to any of the foregoing Clauses, further comprising inputting the speaker source features to a speaker source feature buffer configured to synchronize the speaker source features with the isolate source audio features.

Clause 84. A method according to any of the foregoing Clauses, further comprising inputting the multi-source audio signal sample to an audio buffer configured to synchronize the multi-source audio signal sample with the video signal sample before inputting the multi-source audio signal sample to the audio feature extraction model.

Clause 85. A method according to any of the foregoing Clauses, further comprising: synchronizing the video signal sample with the source separated channel audio sample; and outputting the video signal sample and the source separated channel audio sample to the one or more audio output devices, wherein the one or more audio output devices comprises a downstream audio and video streaming service.

Clause 86. A method according to any of the foregoing Clauses, wherein the video feature extraction model further comprises a speaking indication sub model configured to receive the video signal sample and generate one or more speaker source features associated with one or more lip-based speaking indications.

Clause 87. A method according to any of the foregoing Clauses, wherein the video feature extraction model further comprises a face identification sub model configured to receive the video signal sample and generate one or more speaker source features associated with one or more facial speaking indications.

Clause 88. A method according to any of the foregoing Clauses, further comprising: applying a transformation to the multi-source audio signal sample to generate a transformed multi-source audio signal sample; applying the source separated channel audio mask to the transformed multi-source audio signal sample; and applying an inverse transformation to the multi-source audio signal sample.

Clause 89. A method comprising: receiving one or more isolate source audio features generated from a multi-source audio signal sample associated with at least one audio capture device; analyzing a video signal sample associated with at least one video capture device to determine if the video signal sample satisfies a speaker source feature generation threshold; in a circumstance in which the video signal sample satisfies the speaker source feature generation threshold: engaging a video processing path comprising a video feature extraction model that is configured to generate one or more speaker source features from the video signal sample; inputting the one or more isolate source audio features and the one or more speaker source features to a multi-modal audio source channelization model that is configured to generate a source separated channel audio sample based at least in part on the one or more isolate source audio features and on the one or more speaker source features; in a circumstance in which the video signal sample does not satisfy the speaker source feature generation threshold: inputting the one or more isolate source audio features to an audio only source separation model that is configured to generate an audio-based source separated channel audio sample based on the one or more isolate source audio features; and outputting the source separated channel audio sample or the audio-based source separated channel to one or more audio output devices.

Clause 90. A method according to the foregoing Clause, further comprising engaging a multi-modal channelization route in the circumstance in which the video signal sample satisfies the speaker source feature generation threshold, and wherein the multi-modal channelization route comprises the video processing path and an audio processing path, wherein the audio processing path comprises applying an audio feature extraction model to the multi-source audio signal sample to generate the one or more isolate source audio features.

Clause 91. A method according to any of the foregoing Clauses, further comprising engaging an audio channelization route in the circumstance in which the video signal sample does not satisfy the speaker source feature generation threshold, and wherein the audio channelization route comprises applying an audio feature extraction model to the multi-source audio signal sample to generate the one or more isolate source audio features.

Clause 92. A method according to any of the foregoing Clauses, further comprising a speaker source detector configured to analyze the video signal sample associated with at least one video capture device to determine if the video signal sample satisfies the speaker source feature generation threshold.

Clause 93. A method according to any of the foregoing Clauses, wherein the video signal sample does not satisfy the speaker source feature generation threshold in circumstances in which the audio signal processing apparatus determines that one or more target audio sources associated with the video signal sample are obscured or hidden.

1. An audio signal processing apparatus comprising one or more processors and one or more memories storing instructions that are operable, when executed by the one or more processors, to cause the audio signal processing apparatus to:
input a multi-source audio signal sample associated with at least one audio capture device to an audio feature extraction model that is configured to generate one or more isolate source audio features from the multi-source audio signal sample;
input a video signal sample associated with at least one video capture device to a video feature extraction model that is configured to generate one or more speaker source features from the video signal sample;
input the one or more isolate source audio features and one or more speaker source features to a multi-modal audio source channelization model that is configured to generate a source separated channel audio sample based at least in part on the one or more isolate source audio features and on the one or more speaker source features; and
output the source separated channel audio sample to one or more audio output devices.

2. The audio signal processing apparatus of claim 1, wherein the multi-source audio signal sample is captured by multiple audio capture devices over multiple audio channels.

3. The audio signal processing apparatus of claim 1, wherein the multi-source audio signal sample is captured by one audio capture device over a single audio channel.

4. The audio signal processing apparatus of claim 1, wherein the multi-modal audio source channelization model is configured to further generate a second source separated channel audio sample based at least in part on the one or more isolate source audio features and on the one or more speaker source features, and output the second source separated channel audio sample to one or more audio output devices.

5. The audio signal processing apparatus of claim 4, wherein the source separated channel audio sample is associated with a first target audio source and the second source separated channel audio sample is associated with a second target audio source.

6. The audio signal processing apparatus of claim 1, wherein the one or more speaker source features generated by the video feature extraction model comprise speaking indications associated with human facial images of the video signal sample.

7. The audio signal processing apparatus of claim 1, wherein the one or more speaker source features generated by the video feature extraction model comprise speaking indications associated with human gesture images of the video signal sample.

8. The audio signal processing apparatus of claim 1, wherein the audio signal processing apparatus is further configured to input the multi-source audio signal sample to a source spatialization model to generate isolate source spatial input data associated with the one or more isolate source audio features, and wherein the one or more isolate source audio features, the isolate source spatial input data, and the one or more speaker source features are input to the multi-modal audio source channelization model to generate the source separated channel audio sample.

9. The audio signal processing apparatus of claim 8, wherein the source separated channel audio sample comprises isolate source spatial output data.

10. The audio signal processing apparatus of claim 1, wherein the video signal sample is a multi-feed video signal sample associated with two or more video capture devices.

11-62. (canceled)

63. A method comprising:
inputting a multi-source audio signal sample associated with at least one audio capture device to an audio feature extraction model that is configured to generate one or more isolate source audio features from the multi-source audio signal sample;
inputting a video signal sample associated with at least one video capture device to a video feature extraction model that is configured to generate one or more speaker source features from the video signal sample;
inputting the one or more isolate source audio features and one or more speaker source features to a multi-modal audio source channelization model that is configured to generate a source separated channel audio sample based at least in part on the one or more isolate source audio features and on the one or more speaker source features; and
outputting the source separated channel audio sample to one or more audio output devices.

64. The method of claim 63, wherein the multi-source audio signal sample is captured by multiple audio capture devices over multiple audio channels.

65. The method of claim 63, wherein the multi-source audio signal sample is captured by one audio capture device over a single audio channel.

66. The method of claim 63, wherein the multi-modal audio source channelization model is configured to further generate a second source separated channel audio sample based at least in part on the one or more isolate source audio features and on the one or more speaker source features, and output the second source separated channel audio sample to one or more audio output devices.

67. The method of claim 66, wherein the source separated channel audio sample is associated with a first target audio source and the second source separated channel audio sample is associated with a second target audio source.

68. The method of claim 63, wherein the one or more speaker source features generated by the video feature extraction model comprise speaking indications associated with human facial images of the video signal sample.

69. The method of claim 63, wherein the one or more speaker source features generated by the video feature extraction model comprise speaking indications associated with human gesture images of the video signal sample.

70. The method of claim 63, further comprising inputting the multi-source audio signal sample to a source spatialization model to generate isolate source spatial input data associated with the one or more isolate source audio features, and wherein the one or more isolate source audio features, the isolate source spatial input data, and the one or more speaker source features are input to the multi-modal audio source channelization model to generate the source separated channel audio sample.

71. The method of claim 63, wherein the source separated channel audio sample comprises isolate source spatial output data.

72. The method of claim 63, wherein the video signal sample is a multi-feed video signal sample associated with two or more video capture devices.

73-93. (canceled)
